(19) United States
(12) Patent Application Publication
(10) Pub. No.: US 2024/0074505 A1
(43) Pub. Date: Mar. 7, 2024

(54) AEROSOL-GENERATING DEVICE WITH LOOP-GAP RESONATOR

(71) Applicant: Philip Morris Products S.A., Neuchatel (CH)

(72) Inventors: Hrayr HOVSEPYAN, Yerevan (AM); Arsen HAKHOUMIAN, Ashtarak (AM); Hovhannes HAROYAN, Ashtarak (AM)

(73) Assignee: Philip Morris Products S.A., Neuchatel (CH)

(21) Appl. No.: 18/262,640

(22) PCT Filed: Jan. 5, 2022
(86) PCT No.: PCT/EP2022/050122

§ 371 Date: Jul. 24, 2023

(30) Foreign Application Priority Data
Feb. 1, 2021 (AM) AM20210007

(51) Int. Cl. A24F 40/465; A24D 1/20; A24F 40/10; A24F 40/20; A24F 40/46; H05B 6/02; H05B 6/64

(52) U.S. Cl. CPC A24F 40/465; A24D 1/20; A24F 40/10; A24F 40/20; A24F 40/46; H05B 6/02; H05B 6/64

(57) ABSTRACT

An aerosol-generating device configured to generate aerosol by heating at least one part of an aerosol-generating substrate is provided, the aerosol-generating device including a loop-gap resonator configured to heat the at least one part of the aerosol-generating substrate in order to generate aerosol. An aerosol-generating article for an aerosol-generating device is also provided, the aerosol-generating article including a first portion arranged and/or formed to fit in a loop of a loop-gap resonator of the aerosol-generating device; and a second portion arranged and/or formed to fit in a gap of the loop-gap resonator. An aerosol-generating system is also provided, including the aerosol-generating device and the aerosol-generating article.

The present disclosure generally relates to the field of aerosol-generating devices, systems and apparatuses for generating aerosol. The present disclosure further relates to aerosol-generating substrates and aerosol-generating articles for generating aerosol.

Aerosol-generating devices are typically designed as handheld devices that can be used by a user for consuming or experiencing, for instance in one or more usage sessions, aerosol generated by heating an aerosol-generating substrate or an aerosol-generating article.

Exemplary aerosol-generating substrates can comprise solid substrate material, such as tobacco material or tobacco cast leaves (“TCL”) material. The substrate material can, for example, be assembled, often with other elements or components, to form of a substantially stick-shaped aerosol-generating article. Such a stick or aerosol-generating article can be configured in shape and size to be inserted at least partially into the aerosol-generating device, which, for example, can comprise a heating element for heating the aerosol-generating article and/or the aerosol-generating substrate. Alternatively or additionally, aerosol-generating substrates can comprise one or more liquids and/or solids, which can for example be supplied to the aerosol-generating device in the form of a cartridge or container. Corresponding exemplary aerosol-generating articles can, for example, comprise a cartridge containing or fillable with the liquid and/or solid substrate, which can be vaporized during aerosol consumption by the user based on heating the substrate. Usually, such cartridge or container can be coupled to, attached to or at least partially inserted into the aerosol-generating device. Alternatively, the cartridge may be fixedly mounted to the aerosol-generating device and refilled by inserting liquid and/or solid into the cartridge.

For generating the aerosol during use or consumption, heat can be supplied by a heating element or heat source to heat at least a portion or part of the aerosol-generating substrate. Therein, the heating element or heat source can be arranged in the handheld device or a handheld part of the aerosol-generating device. Alternatively or additionally, at least a part of or the entire heating element or heat source can be fixedly associated with or arranged within an aerosol-generating article, for instance in the form of a stick or cartridge, which can be attached to and/or powered by the handheld device or handheld part of the aerosol-generating device.

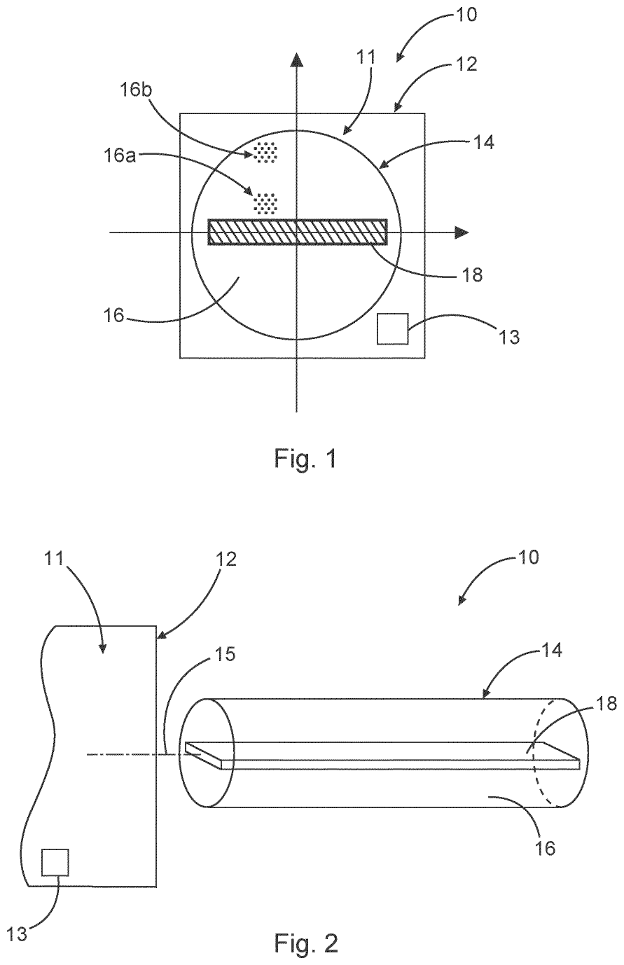

Various forms and designs of heating elements and various heating techniques are currently used in the field of aerosol-generating devices and systems. As also described with reference to FIG. 1 hereinbelow, conventional heating elements can comprise a resistance heating blade arranged in a heating chamber of the aerosol-generating device. The resistance heating element can be brought into contact with the aerosol-generating substrate or article, for example by inserting the substrate or article into the aerosol-generating device, and aerosol can be generated by resistively heating the heating blade. Therein, the heating blade can be subject to mechanical deformation due to the insertion or removal process, which can adversely affect the overall heating of the aerosol-generating substrate. For example, mechanical deformation or abrasion of the heating blade can result in inhomogeneous heating of the substrate, in particular over a plurality of usage sessions or replacements of the aerosol-generating article(s). Moreover, transfer of heat from the heating blade to different portions of the substrate may depend on an orientation of the respective portion of the substrate with respect to the heating blade as well on a distance between the respective portion of the substrate and the heating blade. This may further result in an inhomogeneously heated substrate. In another variant, as for instance described with reference to FIG. 2 hereinbelow, a susceptor or susceptor material may be arranged in the centre of an aerosol-generating article or substrate, for example in the form of a planar metal band of ferromagnetic material at least partly surrounded by aerosol-generating substrate. Also those types of aerosol-generating articles can usually be inserted into the aerosol-generating device for aerosol consumption. Based on applying an alternating magnetic field to the susceptor, for example using a coil arranged in the aerosol-generating device, eddy currents (also called Foucault's currents) can be generated in the susceptor, thereby heating the susceptor and the aerosol-generating substrate in the vicinity thereof. Also in this example, uniform or homogenous heating of the substrate may be hard to achieve due to different orientations and distances of different portions of the substrate with respect to the susceptor. In yet another example, a heating coil can be arranged in a cartridge-like aerosol-generating article to heat a liquid substrate contained therein. Likewise, heat may be supplied locally to the substrate resulting in an inhomogeneous overall heating of the substrate. Such inhomogeneous heating of the substrate may result in an experience for the user that potentially differs among various usage sessions, for example in terms of amount of aerosol generated, in terms of flavour or in terms of taste. Moreover, certain portions or parts of the aerosol-generating substrate may be overheated, thereby potentially generating or releasing undesired substances, while other parts or portions of the substrate may not be sufficiently heated to generate aerosol, thereby potentially resulting in waste of substrate material.

It may, therefore, be desirable to provide for an improved aerosol-generating device, which, for example, at least mitigates or overcomes some or all of the above-mentioned drawbacks of conventional aerosol-generating devices and systems.

This is achieved by the subject-matter of the independent claims. Optional features are provided by the dependent claims and by the following description.

According to a first aspect, there is provided an aerosol-generating device configured to generate aerosol by or based on heating at least one part of an aerosol-generating substrate. The aerosol-generating device comprises at least one loop-gap resonator configured to heat the at least one part of the aerosol-generating substrate in order to generate aerosol.

By providing a loop-gap resonator, hereinafter also referred to as “LGR”, the at least one part of the aerosol-generating substrate may be homogenously heated to a temperature sufficient for generating aerosol, for example a pre-determined or desired temperature. Alternatively or additionally, by using an LGR to heat the at least one part of the aerosol-generating substrate, a mechanically robust and compact aerosol-generating device can be provided. Using an LGR to heat the aerosol-generating substrate may be further advantageous in terms of energy efficiency, for example allowing to heat the at least one part of the substrate at reduced or minimum energy consumption.

In the context of the present disclosure, the loop-gap resonator may refer to an electromagnetic resonator, for example operating in radio and/or microwave frequency ranges, such as kHz to THz frequencies. Generally, an LGR can comprise at least one loop or loop portion and at least one gap or gap portion formed within an electrically conductive body of the LGR, for example integrally formed with the body of the LGR.

In terms of physical or electro-technical properties, an LGR can be modelled as lumped-element circuit or so-called LCR circuit (or LRC circuit). For example, a typical LGR can be considered equivalent to a circuit with an inductor of effective inductance L, a capacitor of effective capacitance C and a resistor of effective resistance R, and optionally a generator, connected in series. Accordingly, an alternating current induced or running in an LGR may depend on the frequency of the current and may reach a maximum at the resonance frequency of the LGR or the corresponding LCR circuit. As used herein, the “resonance frequency” of an LGR may refer to or denote the frequency of an alternating current running in the LGR, where the current reaches its maximum and/or where an impedance of the LGR (or corresponding LCR circuit) reaches a minimum.

As will be discussed in more detail hereinbelow, various types, forms and designs of loop-gap resonators can be used to advantage in the aerosol-generating devices and systems according to the present disclosure. For example, the loop-gap resonator may be at least one of a cylindrical loop-gap-resonator, a tubular loop-gap resonator, a toroidal loop-gap resonator, a spiral loop-gap resonator, a multi-loop loop-gap resonator, and a multi-gap loop-gap resonator. All these different types, forms and designs of LGRs are explicitly envisaged for being used in the aerosol-generating devices and systems according to the present disclosure.

The LGR may, for example, be configured to generate or create an alternating electromagnetic field. Therein, the LGR may be configured to generate one or more regions of alternating electric field, for example within at least one gap or gap portion of the LGR, and one or more regions of alternating magnetic field, for example within at least one loop or loop portion of the LGR. Preferably, the LGR can be configured to generate an alternating electric field and an alternating magnetic field, which can be isolated or separated from one another, and which both can be substantially or approximately uniform. As used herein, an electric or magnetic field may be regarded as “uniform” or “homogenous”, if a strength of the respective field is constant within a maximum relative deviation of about 30%, 25%, 20%, 15%, 10%, or 5%. In turn, one or both of the alternating electric and magnetic fields generated by the LGR can advantageously be used to uniformly and homogenously heat an aerosol-generating substrate to generate aerosol. As used herein, a “uniform heating” or “homogenous heating” may mean that a quantity or amount of heat or thermal energy per volume, which is transferred to or received by the aerosol-generating substrate, is substantially constant or constant within a certain relative deviation, such as for example within a maximum relative deviation of about 30%, 25%, 20%, 15%, 10%, or 5%.

The loop-gap resonator may be configured to heat the at least one part of the aerosol-generating substrate based on one or both of inductive heating, for example based on or using an alternating magnetic field generated by the loop-gap resonator, and microwave heating, for example based on or using an alternating electric field generated by the loop-gap resonator. It should be noted that the LGR can be configured to heat one or more parts or portions of the substrate or a plurality of substrates. For example, the LGR may be configured to heat at least one part or portion of the aerosol-generating substrate based on inductive heating, and optionally heat at least one further part or portion of the aerosol-generating substrate based on microwave heating, or vice versa. Therein, the at least one part of the substrate and the at least one further part of the substrate can be physically separated parts of the substrate or can refer to at least partly identical or overlapping parts of the substrate.

At least one portion of the loop-gap resonator may form or may be formed as a loop of the loop-gap resonator, the loop being configured to receive the at least one part of the aerosol-generating substrate, wherein the loop-gap resonator may be configured to heat the at least one part of the aerosol-generating substrate based on generating an alternating magnetic field within the loop of the loop-gap resonator. As used herein, the “loop” of the LGR may refer to or denote a loop portion of the LGR defining a core or bore of LGR, in which a (e.g. substantially uniform) alternating magnetic field is generated by the LGR. The LGR or the at least one loop or loop portion thereof may be configured to at least partly surround or encompass the at least one part of the aerosol-generating substrate, for example along a perimeter thereof. By receiving the at least one part of the substrate with the loop or loop portion of the LGR, the substrate or the at least one part thereof can be efficiently, uniformly and homogenously heated, particularly at reduced or minimum mechanical wear and energy consumption.

The loop-gap resonator may be configured to heat the at least one part of the aerosol-generating substrate based on inducing eddy currents in a susceptor or susceptor material disposed within and/or deposited on the aerosol-generating substrate. In particular, an alternating magnetic field generated by the LGR can interact with the susceptor or susceptor material and induce eddy currents therein in accordance with Faraday's law. Due to the electrical resistance of the susceptor or susceptor material, an electrical energy associated with the eddy currents can be at least partly converted to thermal energy or heat based on Joules law, which in turn can heat the substrate to generate aerosol. Alternatively or additionally, the LGR can be configured to at least partly heat the substrate based on hysteresis loss, which can result from internal friction of magnetic molecules in the susceptor aligning with the alternating magnetic field generated by the LGR. Also other losses, including domain wall resonance, electron spin resonance and residual losses, may potentially contribute the overall heating of the substrate or the at least one part thereof.

As will also be discussed in more detail hereinbelow, various different types of susceptor or susceptor material can be disposed within and/or deposited on the aerosol-generating substrate, all of which are envisaged by the present disclosure to be optionally used. Generally, the susceptor or the susceptor material may comprise electrically conductive and/or electrically resistive material, such as for example ferromagnetic material, metal or steel. For example, a metal band or planar metal band arranged within the substrate and/or within an aerosol-generating article including the substrate may serve as susceptor. Alternatively or additionally, the susceptor or the susceptor material may be spatially homogeneously distributed within the substrate or at least a part thereof. This may mean that a density of susceptor or susceptor material is substantially constant or is constant within a certain relative deviation, such as for example within a maximum relative deviation of about 30%, 25%, 20%, 15%, 10%, or 5%.

For instance, the susceptor or susceptor material may comprise small and/or small-sized particles of ferromagnetic material arranged within or coated on the aerosol-generating substrate. Alternatively or additionally, the susceptor material can comprise a fluid or liquid having magnetic properties and/or an ionic liquid, which fluid or liquid can be added to or coated onto the substrate, for example coated on a tobacco cast leaves sheet comprised by the substrate or added to a liquid substrate. A homogeneous distribution of susceptor or susceptor material within the substrate may further support or result in a substantially uniform heating (also referred to as “homogenous heating”) of the substrate.

Further, at least two portions of the loop-gap resonator may be arranged opposite to each other and may be spaced apart from each other, such that the at least two portions form a gap of the loop-gap resonator, the gap being configured to receive the at least one part of the aerosol-generating substrate and/or at least one further part of the aerosol-generating substrate. Therein, the loop-gap resonator may be configured to heat the at least one part of the aerosol-generating substrate and/or the at least one further part of the aerosol-generating substrate based on generating an alternating electric field within the gap of the loop-gap resonator. The at least two portions of the LGR may be separated by a certain distance, which may be constant over a length of the gap or may vary over the length of the gap. As used herein, the “gap” of the LGR may refer to or denote a gap portion of the LGR enclosed by the at least two opposing and spaced apart portions of the LGR, in which gap portion a (e.g. substantially uniform) alternating electric field is generated by the LGR. Accordingly, the at least two opposing portions can border the gap or gap portion on at least two opposing sides. The LGR or the at least one gap thereof may be configured to at least partly encompass or enclose the at least one part of the aerosol-generating substrate and/or the at least one further part of the substrate, for example on two opposing sides thereof. By receiving the at least one part of the substrate and/or the at least one further part of the substrate within the gap or gap portion of the LGR, the substrate can be efficiently, uniformly and homogenously heated, particularly at reduced or minimum mechanical wear and energy consumption.

The loop-gap resonator may be at least one of a cylindrical loop-gap-resonator, a tubular loop-gap resonator, a toroidal loop-gap resonator, a spiral loop-gap resonator, a multi-loop loop-gap resonator, and a multi-gap loop-gap resonator. One or more of these types of LGRs may be comprised in the aerosol-generating device to heat the substrate and generate aerosol. Accordingly, the aerosol-generating device may also comprise a plurality of LGRs, for example a plurality of LGRs of the same type or of different types.

A cylindrical or tubular loop-gap resonator may comprise a tubular body forming the loop of the LGR and a slit or cut extending along at least a part of a length of the tubular body, wherein the slit may form the gap or gap portion of the LGR. Therein, the slit or cut may extend parallel to a longitudinal axis of the tubular body of the LGR or transverse thereto. In other words, a tubular or cylindrical LGR may comprise an electrically conductive tubular body or tube cut longitudinally by a slit or gap. The tubular body or tube may act as an inductor with effective inductance L, the gap may act as capacitor with effective capacitance C and the conductive material of the tubular body may act as resistor with effective resistance R. Based on inducing an alternating current running transverse to the longitudinal axis of the tubular body in the LGR, for example in circumferential direction of the tubular body or LGR, a substantially uniform magnetic field, which may be substantially aligned with or parallel to the longitudinal axis, can be generated in the interior volume, core or loop of the tubular body (Bio-Savart law), and a substantially uniform electric field between opposing walls or portions of the LGR defining the gap or gap portion may be generated. As noted above, the alternating magnetic field can be located or confined within the core or loop of the tubular body, while the alternating electric field may be confined in the gap, such that the magnetic and electric field can be separated or isolated from one another. In other words, the alternating electric field may not interfere with the alternating magnetic field, and vice versa, which can allow to use one or both fields independently to heat the substrate or a part thereof.

A toroidal LGR on the other hand can be obtained by joining the two ends of a tubular or cylindrical LGR to form a closed structure. Therein, the magnetic field may be confined within a toroidal or donut shaped resonator or “loop” of the toroidal LGR. The gap can be formed on an inner or outer perimeter of the loop or loop portion and extend along at least a part of a perimeter thereof.

Further, a spiral LGR may refer to an LGR having a substantially spiral body or cross-section, which may for example be obtained when at least two opposing portions of a tubular LGR overlap each other along a circumferential direction of the tubular LGR and are spaced apart from each other in radial direction.

Further, a multi-loop LGR may comprise a plurality of loops or loop portions formed by a body of the LGR. Likewise, a multi-gap LGR can comprise a plurality of gaps formed in a body of the LGR.

The loop-gap resonator may be at least partly arranged in a cartridge or container that may be at least partly fillable with or that may be at least partly filled with the aerosol-generating substrate. Therein, the cartridge or container may be couplable (a) to an external powering device configured to drive the loop-gap resonator and/or (b) to a power supply circuitry of the aerosol-generating device, which power supply circuitry may be configured to drive the loop-gap resonator. Accordingly, the aerosol-generating device according to the present disclosure may include a loop-gap-resonator at least partly arranged in a cartridge configured to contain the aerosol-generating substrate. Such cartridge may be attached or coupled to a further part of the aerosol-generating device, which may comprise a power supply circuitry to drive the loop-gap resonator. Alternatively or additionally, the cartridge with loop-gap-resonator may be coupled or attached to an external powering device, which may for example be a handheld device or handheld part of an aerosol-generating device.

Accordingly, the aerosol-generating device according to the present disclosure may refer to a device, for example a handheld device, which may comprise the loop-gap resonator and optionally further electronics, such as the power supply circuitry for driving or powering the LGR. In an example, the aerosol-generating substrate or an aerosol-generating article comprising the substrate may be at least partly inserted into the aerosol-generating device, for example in the form of a stick.

Alternatively or additionally, however, the aerosol-generating device according to the present disclosure may refer to a device in the form of a cartridge or container, in which the LGR is at least partly arranged. Optionally, also one or more further components, for example at least one feeding loop and/or at least a part of the power supply circuitry, may be arranged in the cartridge or container. Such aerosol-generating device in the form of a cartridge or container can be attached to or coupled to further parts of the aerosol-generating device or to another device, such as a companion device or external powering device, in order to drive or power the LGR to generate aerosol. Such systems may also be referred to as two-part systems and may particularly be used to advantage with liquid substrates, although not limited thereto.

It should be noted that features, functions and/or elements of the external powering device may be similar or identical to features, functions and/or elements of the power supply circuitry, as described hereinabove and hereinbelow. Accordingly, any disclosure about the power supply circuitry presented hereinabove and hereinbelow equally applies to the external powering device, and vice versa.

The aerosol-generating device may further include an aerosol-generating substrate, wherein the loop-gap resonator may be configured to receive the at least one part of the aerosol-generating substrate, for example such that at least a part or portion of the LGR encompasses or encloses the at least one part of the substrate. Optionally, the aerosol-generating substrate and the loop-gap resonator may be at least partly arranged in a cartridge, for example a common cartridge. The cartridge may be pre-filled with substrate and non-refillable or the cartridge may be refilled with substrate by the user.

The aerosol-generating device may further include at least one electrically conductive feeding loop configured to induce eddy currents in at least a portion of the loop-gap resonator and/or configured to excite electromagnetic oscillations in at least a portion of the loop-gap resonator. The at least one feeding loop may refer to a coupling loop configured and/or arranged to generate an alternating magnetic field to induce an alternating current or eddy current within at least a part or portion of the LGR. Depending on the type, shape or form of LGR used, the at least one feeding loop may be arranged at an outer side or end of the LGR, for example in the case of a tubular LGR, or within a part of the LGR, for example in the case of a toroidal LGR. Also a plurality of feeding loops may be used to drive one or more LGRs of the aerosol-generating device.

The at least one feeding loop and the loop-gap resonator, and optionally the aerosol-generating substrate, may be arranged in a cartridge or container. Further, the cartridge may be configured for being coupled, for example electrically and/or mechanically, (a) to an external powering device configured to drive the loop-gap resonator and/or (b) to a power supply circuitry of the aerosol-generating device, which power supply circuitry may be configured to drive the loop-gap resonator.

The aerosol-generating device may further include a power supply circuitry or circuit configured to drive the loop-gap resonator to heat the at least one part of the aerosol-generating substrate based on exciting electromagnetic oscillations in at least a portion of the loop-gap resonator. For supplying electrical energy, the aerosol-generating device may comprise one or more energy storages, for example batteries, accumulators, capacitors, or the like. Alternatively or additionally, the aerosol-generating device may be coupled to or powered by an electrical power supply grid.

Optionally, the aerosol-generating device may include a user interface, for example including a user-actuatable element, configured to receive one or more user inputs. Based on a user input, the aerosol-generating device may be configured to activate the power supply circuitry to drive the LGR in order to generate aerosol. For this purpose, the aerosol-generating device may optionally comprise a control circuitry with one or more processors or controllers, which may be coupled to the power supply circuitry.

The power supply circuitry may be configured to excite electromagnetic oscillations in the loop-gap resonator at or near a resonance frequency of the loop-gap resonator. As mentioned above, at or near the resonance frequency of the LGR, the induced alternating current may reach a maximum, which in turn can result in a maximum heating effect achievable with the LGR at certain power level or power input. Accordingly, driving the LGR at or near its resonance frequency may allow for an energy efficient and fast heating. As used herein, “at or near the resonance frequency” may mean at the resonance frequency within a certain relative deviation, such as for example within a maximum relative deviation of about 30%, 25%, 20%, 15%, 10%, or 5%.

The power supply circuitry may be configured to drive the loop-gap resonator, such that an alternating magnetic field may be generated in a loop or loop portion, for example in a core, of the loop-gap resonator, the loop or loop portion being configured to receive the at least one part of the aerosol-generating substrate. Accordingly, the at least one part of the substrate may be arranged within the loop or loop portion of the LGR, such that the LGR may at least partly encompass the at least one part of the substrate. Due to the uniform alternating magnetic field generated by the LGR and applied to the substrate, the substrate or the at least one part thereof may be uniformly heated, for example to a pre-determined or desired temperature that may be suitable for generating aerosol.

Alternatively or additionally, the power supply circuitry may be configured to drive the loop-gap resonator, such that an alternating electric field may be generated in a gap or gap portion of the loop-gap resonator, the gap or gap portion being configured to receive the at least one part of the aerosol-generating substrate and/or at least one further part of the aerosol-generating substrate. Accordingly, the at least one part and/or the at least one further of the substrate may be arranged within the gap or gap portion of the LGR, such that the LGR may at least partly encompass the at least one (further) part of the substrate. Due to the uniform alternating electric field generated by the LGR and applied to the substrate, the substrate or the at least one (further) part thereof may be uniformly heated, for example to a pre-determined or desired temperature that may be suitable for generating aerosol.

Generally, the power supply circuitry may be configured to drive the loop-gap resonator based on inductive coupling. For example, the power supply circuitry may be configured to drive the loop-gap resonator based on inducing eddy currents in the loop-gap resonator, for example flowing transverse to a longitudinal axis of the loop-gap resonator.

By way of example, the power supply circuitry may include at least one electrically conductive feeding loop or coupling loop, for example arranged at an end or side of the loop-gap resonator or within the loop-gap resonator. Therein, the power supply circuitry may be configured to drive the loop-gap resonator based on supplying an alternating current to the at least one feeding loop. Such alternating current may create an alternating magnetic field around the feeding loop, which can in turn induce eddy currents in the LGR or at least a part thereof. These eddy currents, in turn, can generate the alternating magnetic field within the loop or loop portion of the LGR and the alternating electric field in the gap or gap portion of the LGR, one or both of which can advantageously be used to uniformly heat the substrate.

The at least one feeding loop of the power supply circuitry may, for example, be arranged coaxially with a loop or loop portion of the loop-gap resonator. This may ensure an efficient inductive coupling between the feeding loop and the LGR.

In an example, the at least one feeding loop may be formed by an end of an inner conductor of a coaxial cable, which end is short-circuited with an outer conductor of the coaxial cable. In other words, the feeding loop may be constituted by a part of coaxial cable formed into a loop, where the outer conductor, and where optionally an outside jacket and an insulator layer may be removed. A centre cable of the coaxial cable may then be short circuited with the remaining part of the outer conductor. The centre cable and the outer conductor may provide two electrical terminals, between which an alternative current can be generated to drive the LGR. An advantage of such design of the feeding loop may be that only the feeding loop generates a magnetic field, while remaining parts of the coaxial cable may be shielded.

Further, a frequency of the alternating current running in the feeding loop may be similar, identical or at least proportional to a frequency of the alternating magnetic field generated in the LGR. Accordingly, the power supply circuitry and/or a control circuitry of the aerosol-generating device may be configured to adjust, vary, and/or control a temperature, to which the at least one part of the substrate is or should be heated, based on adjusting, varying and/or controlling a frequency of the alternating current supplied to the feeding loop and/or based on adjusting, varying and/or controlling a frequency of the alternating magnetic field generated in the LGR. Hence, a precise temperature control may be provided. Alternatively or additionally, a strength of the alternating current in the feeding loop, a strength of the alternating magnetic field in the LGR, a frequency of the alternating electric field in the LGR and/or a strength of the alternating electric field in the LGR may be adjusted, varied and/or controlled.

Alternatively or additionally, the power supply circuitry may be configured to drive the loop-gap resonator based on capacitive coupling. By way of example, the power supply circuitry may include one or more electrodes configured to capacitively couple to a capacitor formed by a slit or gap of the loop-gap resonator. In other words, the power supply circuitry may be configured to capacitively induce an alternating electric field in a capacitor formed by a slit or gap of the loop-gap resonator. The one or more electrodes may be configured to generate an alternating electric field which can capacitively couple to the capacitor formed or defined by the gap or slit of the LGR. Based on adjusting, varying and/or controlling one or both of a frequency and a field strength the alternating electric field generated by the one or more electrodes, the power supply circuitry and/or the control circuitry of the aerosol-generating device may be configured to adjust, vary and/or control the temperature, to which the at least one part of the substrate is or should be heated.

Alternatively or additionally, the power supply circuitry may include an electromagnetic wave generator configured to excite electromagnetic oscillations, eddy currents, an alternating magnetic field and/or an alternating electric field in at least a portion of the loop-gap resonator to drive the loop-gap resonator.

The aerosol-generating device may further include a heating chamber or heating compartment configured to receive the at least one part of the aerosol-generating substrate and/or an aerosol-generating article including the aerosol-generating substrate. The heating chamber or compartment may, for example, be arranged within a housing of the aerosol-generating device. Optionally, the loop-gap resonator may be at least partly arranged in the heating chamber or compartment and configured to at least partly encompass the at least one part of the aerosol-generating substrate, for example along a perimeter thereof.

In an example, the loop-gap resonator can be substantially tubular shaped. In other words, the loop-gap resonator may be a tubular or cylindrical loop-gap resonator. Therein, a longitudinal axis of the loop-gap resonator may extend substantially parallel to an insertion direction of the aerosol-generating device, along which the at least one part of the aerosol-generating substrate and/or an aerosol-generating article including the aerosol-generating substrate can be at least partly inserted into the aerosol-generating device.

The loop-gap resonator may include a tubular body, the tubular body defining a loop, loop portion or core of the loop-gap resonator configured to receive and/or at least partly encompass the at least one part of the aerosol-generating substrate, wherein the loop-gap resonator may be configured to heat the at least one part of the aerosol-generating substrate based on generating an alternating magnetic field within the loop, loop portion or core of the loop-gap resonator.

Alternatively or additionally, the loop-gap resonator may include a tubular body with a slit extending along at least a part of or the entire length of the tubular body. For example, the slit may extend parallel to a longitudinal axis of the loop-gap resonator or the tubular body thereof. Alternatively, the slit may extend transverse to the longitudinal axis, for example, spiral-like along a length of the tubular body.

The loop-gap resonator may include a tubular body with a slit, the slit defining a gap or gap portion of the loop-gap resonator configured to receive and/or encompass the at least one part of the aerosol-generating substrate and/or at least one further part of the substrate. Therein, the loop-gap resonator may be configured to heat the at least one part and/or the at least one further part of the aerosol-generating substrate based on generating an alternating electric field within the gap or gap portion of the loop-gap resonator.

As mentioned above, the aerosol-generating device may include a plurality of loop-gap resonators, for example arranged coaxially with respect to each other or next to each other. Therein, loop-gap resonators of the same or different types may be used to heat the same or different aerosol-generating substrates or articles.

A second aspect of the present disclosure relates to a use of a loop-gap resonator in an aerosol-generating device or an aerosol-generating system for heating at least a part of an aerosol-generating substrate, which may optionally be at least partly insertable into the aerosol-generating device. Any feature function and/or element of the aerosol-generating device or system, described hereinabove and hereinbelow, equally applies to the use of the aerosol-generating device or system.

According to a third aspect of the present disclosure, there is provided an aerosol-generating article for an aerosol-generating device, for example an aerosol-generating device including a loop-gap resonator configured to heat at least one part of the aerosol-generating article. The aerosol-generating article comprises at least one of:
a first portion arranged, shaped, configured and/or formed to fit in a loop of a loop-gap resonator; and
a second portion arranged, shaped, configured and/or formed to fit in a gap of the loop-gap resonator.

The aerosol-generating article may further include a loop-gap resonator configured to heat one or both of the first portion and the second portion of the aerosol-generating article. In the context of the present disclosure, “an aerosol-generating article comprising a loop-gap resonator” may also be referred to as “aerosol-generating device”. In other words, an aerosol-generating article including one or both of the first and second portion of the aerosol-generating article and a loop-gap resonator may be referred to as “aerosol-generating device” hereinabove and hereinbelow.

Accordingly, any feature function and/or element described with reference to the aerosol-generating device hereinabove and hereinbelow equally applies to the one or more aerosol-generating articles described hereinabove and hereinbelow.

In an example, the first portion may be substantially cylindrically shaped. The first portion of the aerosol-generating article may be formed in shape and size to substantially fit within the loop or loop portion of the LGR. Accordingly, the first portion of the aerosol-generating article may be formed in correspondence with the loop or loop portion of the LGR. Such corresponding geometry can support or ensure a uniform heating of the first portion of the aerosol-generating article.

Alternatively or additionally, the second portion may be substantially bar-like shaped and/or formed as parallelepiped. The second portion of the aerosol-generating article may be formed in shape and size to substantially fit within the gap or gap portion of the LGR. Accordingly, the second portion of the aerosol-generating article may be formed in correspondence with the gap or gap portion of the LGR. Such corresponding geometry can support or ensure a uniform heating of the second portion of the aerosol-generating article.

The aerosol-generating article may be key-like shaped. For example, the second portion may protrude fin-like from the first portion of the aerosol-generating article. Accordingly, the second portion may be coupled or attached to the first portion of the aerosol-generating article, such that the aerosol-generating article may establish a substantially key-like shape. In other words, the second portion may constitute a bit of the substantially key-shaped aerosol-generating article. Accordingly, the aerosol-generating article may be formed in shape and size, such that the first portion fits in the loop of the LGR and such that the second portion fits in the gap of the LGR. Hence, one or both of the magnetic field generated by the LGR in the loop and the electric field generated by the LGR in the gap can be used to heat the first and/or second portion of the substrate.

The first portion of the aerosol-generating article may include a first aerosol-generating substrate configured for being heated to generate aerosol, and the second portion of the aerosol-generating article may include a second aerosol-generating substrate configured for being heated to generate aerosol, the second aerosol-generating substrate being different than the first aerosol-generating substrate. In other words, the first and second portions of the aerosol-generating article may include differing or different substrates. Therein, the first and second substrates may differ in type or form, such as a liquid or solid substrate, and/or in any other property, such as a material density, a density of aerosol-generating material or substance of the substrates, a material composition, one or more ingredients or any other property or characteristic of the substrates. Alternatively or additionally, the first aerosol-generating substrate and the second aerosol-generating substrate may differ from one another in one or more of a degree of humidity, a type of tobacco, a flavour, and a taste, for example a taste or flavour of an airflow containing the generated aerosol.

In an example, the first aerosol-generating substrate may include a susceptor or susceptor material configured to heat the first aerosol-generating substrate based on inductive heating. Alternatively or additionally, the second aerosol-generating substrate may be configured for being heated based on microwave heating and/or may not comprise a susceptor or susceptor material. For example, the second aerosol-generating substrate may have a certain minimum level of humidity, for instance residual humidity, to allow for an efficient and effective microwave heating when exposed to an alternating electric field in the gap of the LGR.

The aerosol-generating article may further include a mouthpiece, and an air-flow path configured to transfer aerosol towards the mouthpiece. Therein, the air-flow path may include a first flow-path portion coupled to the first portion of the aerosol-generating article and configured to transfer aerosol generated in the first portion of the aerosol-generating article towards the mouthpiece. Alternatively or additionally, the air-flow path may include a second flow-path portion coupled to the second portion of the aerosol-generating article and configured to transfer aerosol generated in the second portion of the aerosol-generating article towards the mouthpiece. By the first and/or second air-flow path portions, aerosol generated by the first and/or second portion of the aerosol-generating article can be efficiently guided or directed towards the mouthpiece, which can enhance an overall experience for the user, for example in terms of taste or flavour.

Optionally, the second flow-path portion may be coupled to the first flow-path portion, such that aerosol generated in the first portion and the second portion of the aerosol-generating article may be mixed when transferred by the air-flow path towards the mouthpiece. By mixing the aerosol generated by the first and second portions or by mixing corresponding air flows carrying the aerosol from the first and second portion towards the mouthpiece, the overall experience for the user may be further improved. In particular, a substantially constant taste or flavour may be provided over a plurality of subsequent usage sessions.

A fourth aspect of the present disclosure relates to a use of one or more aerosol-generating articles, as described hereinabove and hereinbelow, in particular a use thereof in an aerosol-generating device or system, as described hereinabove and hereinbelow.

According to a fifth aspect of the present disclosure, there is provided an aerosol-generating system. The system comprises an aerosol-generating device, as described hereinabove and hereinbelow, and one of the aerosol-generating articles, as described hereinabove and hereinbelow.

Any disclosure presented hereinabove and hereinbelow with respect to any of the aerosol-generating device and the one or more aerosol-generating articles, equally applies to the aerosol-generating system, and vice versa.

According to a sixth aspect of the present disclosure, there is provided an aerosol-generating article for an aerosol-generating device, for example including a loop-gap resonator, wherein at least a portion of the aerosol-generating article is formed to fit in a gap of the loop-gap resonator of the aerosol-generating article or an aerosol-generating device. For example, the at least one portion of the aerosol-generating article may be substantially bar-like shaped and/or formed as parallelepiped. Alternatively or additionally, the at least one portion of the aerosol-generating article may be shaped in correspondence with a shape, geometry and/or size of a gap of the loop-gap resonator. For example, the at least one portion of the aerosol-generating article may be configured for being heated based on microwave heating.

A seventh aspect of the present disclosure relates to a use of such aerosol-generating article in an aerosol-generating device, for example an aerosol-generating device described hereinabove and hereinbelow.

According to an eight aspect of the present disclosure, there is provided an aerosol-generating article for an aerosol-generating device, for example including a loop-gap resonator. The aerosol-generating article comprises an aerosol-generating substrate for generating aerosol, and a susceptor or susceptor material configured to heat at least a part of the aerosol-generating substrate to generate aerosol.

The aerosol-generating article may further include a compartment containing the aerosol-generating substrate and the susceptor.

In an example, the susceptor or susceptor material may be spatially homogenously distributed in or within the compartment. Such homogenous distribution of susceptor may further enhance or assist in uniformly heating the substrate or at least a part thereof.

The susceptor or susceptor material may include one or more threads or bands comprising ferromagnetic material. Such threads or bands may be randomly distributed within the substrate or may be at least partly aligned, for instance with respect to each other and/or with respect to one or more structures of the substrate.

In an example, the aerosol-generating substrate may be folded to create one or more folds, wherein the one or more threads or bands of the susceptor may be arranged in and/or aligned with the one or more folds of the aerosol-generating substrate. Also in such configuration, substantially uniform heating can be ensured.

The susceptor or susceptor material may include one or more particles of ferromagnetic material. By way of example, the one or more particles may be disposed within the aerosol-generating substrate, for example randomly disposed and/or oriented within the substrate. For example, a solid substrate, such as a tobacco cast leaves sheet comprised by the substrate, may be at least partly soaked with a liquid containing the one or more particles in order to randomly and homogenously dispose the particles within the substrate. In other words, the aerosol-generating substrate or at least a part thereof may be soaked with a fluid containing the one or more particles. In case of a liquid substrate, the one or more particles may be dissolved in the liquid substrate to provide a homogenous particle distribution.

Alternatively or additionally, the one or more particles may be deposited on the aerosol-generating substrate, for example in the form of a coating onto a solid substrate. Accordingly, the aerosol-generating substrate may be coated with the one or more particles. For instance, the one or more particles can be deposited on or onto the aerosol-generating substrate by or based on physical vapor deposition.

Optionally, the one or more particles may be or comprise magnetic iron oxide particles.

Alternatively or additionally, the susceptor or susceptor material may include one or more ferrite slabs. Optionally, the one or more ferrite slabs may be spatially homogenously disposed within the aerosol-generating substrate and/or with an aerosol-generating article.

A ninth aspect of the present disclosure relates to a use of an aerosol-generating article, for example the aerosol-generating article according to the eighth aspect of the present disclosure, in an aerosol-generating device, for example the aerosol-generating device according to the first aspect of the present disclosure.

In the following, various exemplary or optional features of one or more aerosol-generating articles comprising a susceptor or susceptor material are summarized. For example, one or more threads or bands of ferromagnetic material may be used as susceptor or susceptor material. Such threads or bands may be arranged on one or more sheets of aerosol-generating substrate, for example before compressing the one or more sheets into an aerosol-generating article.

Alternatively or additionally, such threads or bands may be fed into or added to the aerosol-generating article during compressing the one or more sheets, for example such that the one or more threads or bands can get caught in one or more longitudinal folds of the one or more sheets, thereby aligning the threads or bands with respect to each other and/or with respect to the one or more folds.

Alternatively or additionally, small particles of ferromagnetic material may be inserted into the substrate and/or the substrate may be coated with such particles. Such particles, for instance magnetic iron oxide particles, which can be used for medical magnetic hyperthermia applications, may be added to a tobacco powder which may be used to produce one or more tobacco cast leaves sheets, which may ensure or result in a homogenous spatial distribution of the particles within the one or more sheets.

Alternatively or additionally, such particles could be physically deposited on the one or more sheets during a manufacturing process thereof. For instance, a sheet may be arranged in a chamber, where it may be expelled to a cloud of such particles. Alternatively or additionally, Physical Vapor Deposition (PVD) may be used to produce a thin film of such particles on a sheet of substrate.

Alternatively or additionally, such particles may be inserted into a fluid added to and/or coating the one or more sheets. For instance, such fluid may be added during manufacturing of the one or more sheets, and/or may be spayed or deposited onto the one or more sheets.

Alternatively or additionally, ferrite slabs may be added to the one or more sheets as susceptor material. In case the susceptor comprises particles or slabs, the latter can be referred to as “dopants”.

It is emphasized that any feature, step, function, element, technical effect and/or advantage described herein with reference to one aspect equally applies to any other aspect of the present disclosure.

Below, there is provided a non-exhaustive list of non-limiting examples. Any one or more of the features of these examples may be combined with any one or more features of another example, embodiment, or aspect described herein.

Example 1: An aerosol-generating device configured to generate aerosol by heating at least one part of an aerosol-generating substrate, the aerosol-generating device comprising:
at least one loop-gap resonator configured to heat the at least one part of the aerosol-generating substrate in order to generate aerosol.

Example 2: The aerosol-generating device of example 1, wherein the loop-gap resonator is configured to heat the at least one part of the aerosol-generating substrate based on one or both of inductive heating and microwave heating.

Example 3: The aerosol-generating device according to any preceding example, wherein at least one portion of the loop-gap resonator forms a loop of the loop-gap resonator, the loop being configured to receive the at least one part of the aerosol-generating substrate; and wherein the loop-gap resonator is configured to heat the at least one part of the aerosol-generating substrate based on generating an alternating magnetic field within the loop of the loop-gap resonator.

Example 4: The aerosol-generating device according to any preceding example, wherein at least two portions of the loop-gap resonator are arranged opposite to each other and are spaced apart from each other, such that the at least two portions form a gap of the loop-gap resonator, the gap being configured to receive the at least one part of the aerosol-generating substrate; and wherein the loop-gap resonator is configured to heat the at least one part of the aerosol-generating substrate based on generating an alternating electric field within the gap of the loop-gap resonator.

Example 5: The aerosol-generating device of any preceding example, wherein the loop-gap resonator is configured to heat the at least one part of the aerosol-generating substrate based on inducing eddy currents in a susceptor disposed within and/or deposited on the aerosol-generating substrate.

Example 6: The aerosol-generating device according to any preceding example, wherein the loop-gap resonator is at least one of a cylindrical loop-gap-resonator, a tubular loop-gap resonator, a toroidal loop-gap resonator, a spiral loop-gap resonator, a multi-loop loop-gap resonator, and a multi-gap loop-gap resonator.

Example 7: The aerosol-generating device according to any preceding example, wherein the loop-gap resonator is at least partly arranged in a cartridge that is at least partly fillable with or filled with the aerosol-generating substrate; and wherein the cartridge is couplable (a) to an external powering device configured to drive the loop-gap resonator and/or (b) to a power supply circuitry of the aerosol-generating device, which power supply circuitry is configured to drive the loop-gap resonator.

Example 8: The aerosol-generating device according to any preceding example, further including:
an aerosol-generating substrate;
wherein the loop-gap resonator is configured to receive the at least one part of the aerosol-generating substrate; optionally wherein the aerosol-generating substrate and the loop-gap resonator are at least partly arranged in a cartridge.

Example 9: The aerosol-generating device according to any preceding example, further including:
at least one electrically conductive feeding loop configured to induce eddy currents in at least a portion of the loop-gap resonator and/or configured to excite electromagnetic oscillations in at least a portion of the loop-gap resonator.

Example 10: The aerosol-generating device according to example 9, wherein the at least one feeding loop and the loop-gap resonator are arranged in a cartridge; and wherein the cartridge is configured for being coupled to (a) to an external powering device configured to drive the loop-gap resonator and/or (b) to a power supply circuitry of the aerosol-generating device, which power supply circuitry is configured to drive the loop-gap resonator.

Example 11: The aerosol-generating device of any preceding example, further including:
a power supply circuitry configured to drive the loop-gap resonator to heat the at least one part of the aerosol-generating substrate based on exciting electromagnetic oscillations in at least a portion of the loop-gap resonator.

Example 12: The aerosol-generating device of example 11, wherein the power supply circuitry is configured to excite electromagnetic oscillations in the loop-gap resonator at or near a resonance frequency of the loop-gap resonator.

Example 13: The aerosol-generating device of any of examples 11 and 12, wherein the power supply circuitry is configured to drive the loop-gap resonator, such that an alternating magnetic field is generated in a loop of the loop-gap resonator, the loop being configured to receive the at least one part of the aerosol-generating substrate.

Example 14: The aerosol-generating device of any of examples 11 to 13, wherein the power supply circuitry is configured to drive the loop-gap resonator, such that an alternating electric field is generated in a gap of the loop-gap resonator, the gap being configured to receive the at least one part of the aerosol-generating substrate.

Example 15: The aerosol-generating device of any of examples 11 to 14, wherein the power supply circuitry is configured to drive the loop-gap resonator based on inductive coupling.

Example 16: The aerosol-generating device of any of examples 11 to 15, wherein the power supply circuitry is configured to drive the loop-gap resonator based on inducing eddy currents in the loop-gap resonator.

Example 17: The aerosol-generating device of any of examples 11 to 16, wherein the power supply circuitry includes at least one electrically conductive feeding loop; and wherein the power supply circuitry is configured to drive the loop-gap resonator based on supplying an alternating current to the at least one feeding loop.

Example 18: The aerosol-generating device of example 17, wherein the at least one feeding loop is arranged coaxially with a loop of the loop-gap resonator.

Example 19: The aerosol-generating device of example 18, wherein the at least one feeding loop is formed by an end of an inner conductor of a coaxial cable short-circuited with an outer conductor of the coaxial cable.

Example 20: The aerosol-generating device of any of examples 11 to 19, wherein the power supply circuitry is configured to drive the loop-gap resonator based on capacitive coupling.

Example 21: The aerosol-generating device of example 20, wherein the power supply circuitry includes one or more electrodes configured to capacitively couple to a capacitor formed by a slit or gap of the loop-gap resonator.

Example 22: The aerosol-generating device of any of examples 20 and 21, wherein the power supply circuitry is configured to capacitively induce an alternating electric field in a capacitor formed by a slit or gap of the loop-gap resonator.

Example 23: The aerosol-generating device of any of examples 11 to 22, wherein the power supply circuitry includes an electromagnetic wave generator configured to excite electromagnetic oscillations in at least a portion of the loop-gap resonator to drive the loop-gap resonator.

Example 24: The aerosol-generating device of any of preceding example, further including:

a heating chamber configured to receive the at least one part of the aerosol-generating substrate; wherein the loop-gap resonator is at least partly arranged in the heating chamber and configured to at least partly encompass the at least one part of the aerosol-generating substrate.

Example 25: The aerosol-generating device of any of preceding example, wherein the loop-gap resonator is substantially tubular shaped; and wherein a longitudinal axis of the loop-gap resonator extends substantially parallel to an insertion direction of the aerosol-generating device, along which the at least one part of the aerosol-generating substrate is at least partly insertable into the aerosol-generating device.

Example 26: The aerosol-generating device of any of preceding example, wherein the loop-gap resonator includes a tubular body, the tubular body defining a loop of the loop-gap resonator configured to receive the at least one part of the aerosol-generating substrate; and wherein the loop-gap resonator is configured to heat the at least one part of the aerosol-generating substrate based on generating an alternating magnetic field within the loop of the loop-gap resonator.

Example 27: The aerosol-generating device of any preceding example, wherein the loop-gap resonator includes a tubular body with a slit extending along a length of the tubular body.

Example 28: The aerosol-generating device of any preceding example, wherein the loop-gap resonator includes a tubular body with a slit, the slit defining a gap of the loop-gap resonator configured to receive the at least one part of the aerosol-generating substrate; and wherein the loop-gap resonator is configured to heat the at least one part of the aerosol-generating substrate based on generating an alternating electric field within the gap of the loop-gap resonator.

Example 29: The aerosol-generating device of any preceding example, wherein the aerosol-generating device includes a plurality of loop-gap resonators arranged coaxially with respect to each other.

Example 30: Use of a loop-gap resonator in an aerosol-generating device for heating at least a part of an aerosol-generating substrate.

Example 31: An aerosol-generating article for an aerosol-generating device, the aerosol-generating article comprising at least one of:
a first portion arranged and/or formed to fit in a loop of a loop-gap resonator of the aerosol-generating device; and
a second portion arranged and/or formed to fit in a gap of the loop-gap resonator.

Example 32: The aerosol-generating article of example 31, further including:
a loop-gap resonator configured to heat one or both of the first portion and the second portion of the aerosol-generating article.

Example 33: The aerosol-generating article of any of examples 31 to 32, wherein the first portion is substantially cylindrically shaped.

Example 34: The aerosol-generating article of any of examples 31 to 33, wherein the second portion is substantially bar-like shaped; and/or wherein the second portion is formed as parallelepiped.

Example 35: The aerosol-generating article of any of examples 31 to 34, wherein the aerosol-generating article is key-like shaped.

Example 36: The aerosol-generating article of any of examples 31 to 35, wherein the second portion protrudes fin-like from the first portion of the aerosol-generating article.

Example 37: The aerosol-generating article of any of examples 31 to 36, wherein the first portion includes a first aerosol-generating substrate configured for being heated to generate aerosol; and wherein the second portion includes a second aerosol-generating substrate configured for being heated to generate aerosol, the second aerosol-generating substrate being different than the first aerosol-generating substrate.

Example 38: The aerosol-generating article of example 37, wherein the first aerosol-generating substrate includes a susceptor configured to heat the first aerosol-generating substrate based on inductive heating.

Example 39: The aerosol-generating article of any of examples 37 and 38, wherein the second aerosol-generating substrate is configured for being heated based on microwave heating.

Example 40: The aerosol-generating article of any of examples 37 to 39, wherein the first aerosol-generating substrate and the second aerosol-generating substrate differ in one or more of a degree of humidity, a type of tobacco, a flavour, and a taste.

Example 41: The aerosol-generating article of any of examples 31 to 40, further including:
a mouthpiece; and
an air-flow path configured to transfer aerosol towards the mouthpiece;
wherein the air-flow path includes a first flow-path portion coupled to the first portion of the aerosol-generating article and configured to transfer aerosol generated in the first portion of the aerosol-generating article towards the mouthpiece; and wherein the air-flow path includes a second flow-path portion coupled to the second portion of the aerosol-generating article and configured to transfer aerosol generated in the second portion of the aerosol-generating article towards the mouthpiece.

Example 42: The aerosol-generating article of example 41, wherein the second flow-path portion is coupled to the first flow-path portion, such that aerosol generated in the first portion and the second portion of the aerosol-generating article is mixed when transferred by the air-flow path towards the mouthpiece.

Example 43: Use of an aerosol-generating article according to any of examples 31 to 42 in an aerosol-generating device.

Example 44: An aerosol-generating system, comprising:
an aerosol-generating device according to any of examples 1 to 29; and
an aerosol-generating article according to any of examples 31 to 42.

Example 45: An aerosol-generating article for an aerosol-generating device, wherein at least a portion of the aerosol-generating article is formed to fit in a gap of a loop-gap resonator.

Example 46: The aerosol-generating article of example 45, wherein the at least portion of the aerosol-generating article is substantially bar-like shaped and/or formed as parallelepiped.

Example 47: The aerosol-generating article of any of examples 45 and 46, wherein the at least portion of the aerosol-generating article is shaped in correspondence with a shape of a gap of the loop-gap resonator.

Example 48: The aerosol-generating article of any of examples 45 and 47, wherein the at least portion of the aerosol-generating article is configured for being heated based on microwave heating.

Example 49: Use of an aerosol-generating article according to any of examples 45 to 48 in an aerosol-generating device.

Example 50: An aerosol-generating article for an aerosol-generating device, the aerosol-generating article comprising:
an aerosol-generating substrate for generating aerosol; and
a susceptor configured to heat at least a part of the aerosol-generating substrate to generate aerosol.

Example 51: The aerosol-generating article of example 50, further including:
a compartment containing the aerosol-generating substrate and the susceptor.

Example 52: The aerosol-generating article of any of examples 50 to 51, wherein the susceptor is spatially homogenously distributed in the compartment.

Example 53: The aerosol-generating article of any of examples 50 to 52, wherein the susceptor includes one or more threads comprising ferromagnetic material.

Example 54: The aerosol-generating article of example 53, wherein the aerosol-generating substrate is folded to create one or more folds; and wherein the one or more threads of the susceptor are arranged in and/or aligned with the one or more folds of the aerosol-generating substrate.

Example 55: The aerosol-generating article of any of examples 50 to 54, wherein the susceptor includes one or more particles of ferromagnetic material.

Example 56: The aerosol-generating article of example 55, wherein the one or more particles are disposed within the aerosol-generating substrate.

Example 57: The aerosol-generating article of any of examples 55 and 56, wherein the one or more particles are deposited on the aerosol-generating substrate.

Example 58: The aerosol-generating article of example 57, wherein the one or more particles are deposited on the aerosol-generating substrate by physical vapor deposition.

Example 59: The aerosol-generating article of any of examples 55 to 58, wherein the one or more particles are magnetic iron oxide particles.

Example 60: The aerosol-generating article of any of examples 55 to 59, wherein the aerosol-generating substrate is coated with the one or more particles.

Example 61: The aerosol-generating article of any of examples 55 to 60, wherein the aerosol-generating substrate is soaked with a fluid containing the one or more particles.

Example 62: The aerosol-generating article of any of examples 50 to 61, wherein the susceptor includes one or more ferrite slabs.

Example 63: The aerosol-generating article of any example 62, wherein the one or more ferrite slabs are spatially homogenously disposed within the aerosol-generating substrate.

Example 64: Use of an aerosol-generating article according to any of examples 50 to 63 in an aerosol-generating device.

Examples will now be further described with reference to the Figures in which:

FIG. 1 shows a cross-sectional view of an aerosol-generating system for generating aerosol;

FIG. 2 shows a perspective view of a part of an aerosol-generating system for generating aerosol;

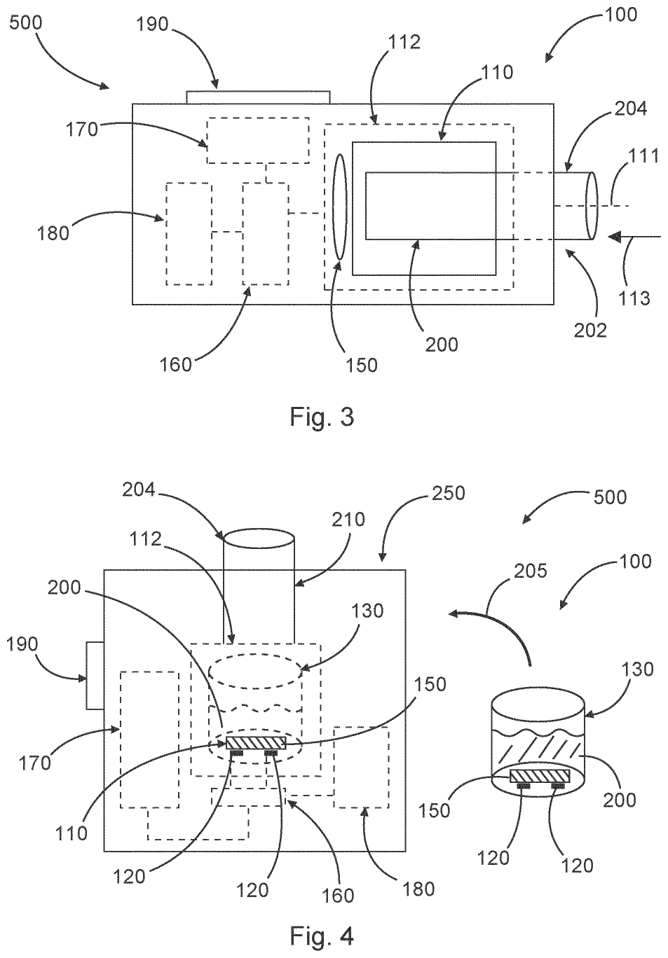

FIG. 3 shows an aerosol-generating device for generating aerosol;

FIG. 4 shows an aerosol-generating system for generating aerosol;

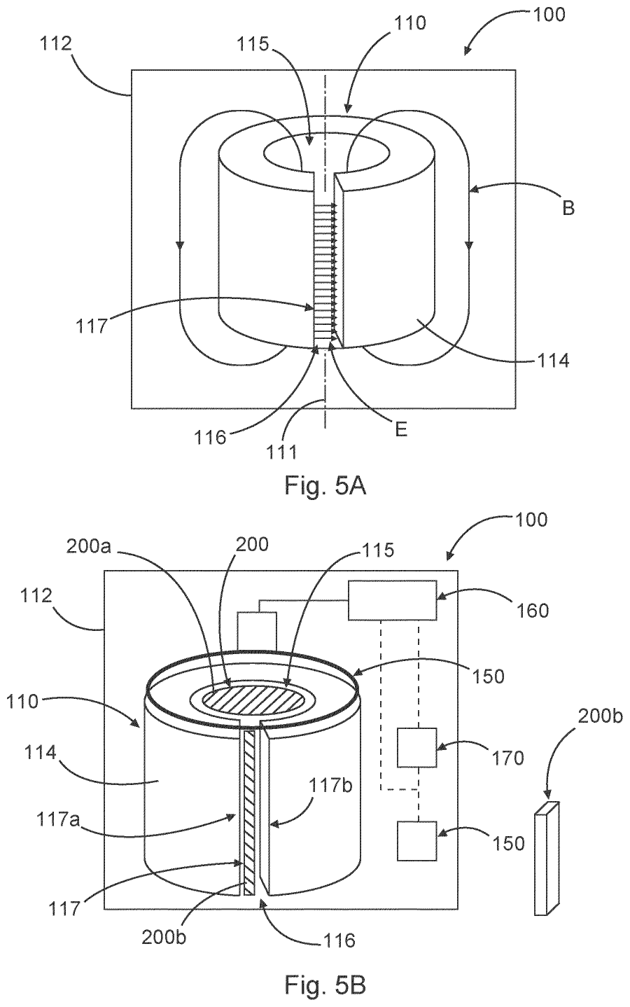

FIGS. 5A and 5B each show a detailed view of a part of an aerosol-generating device for generating aerosol;

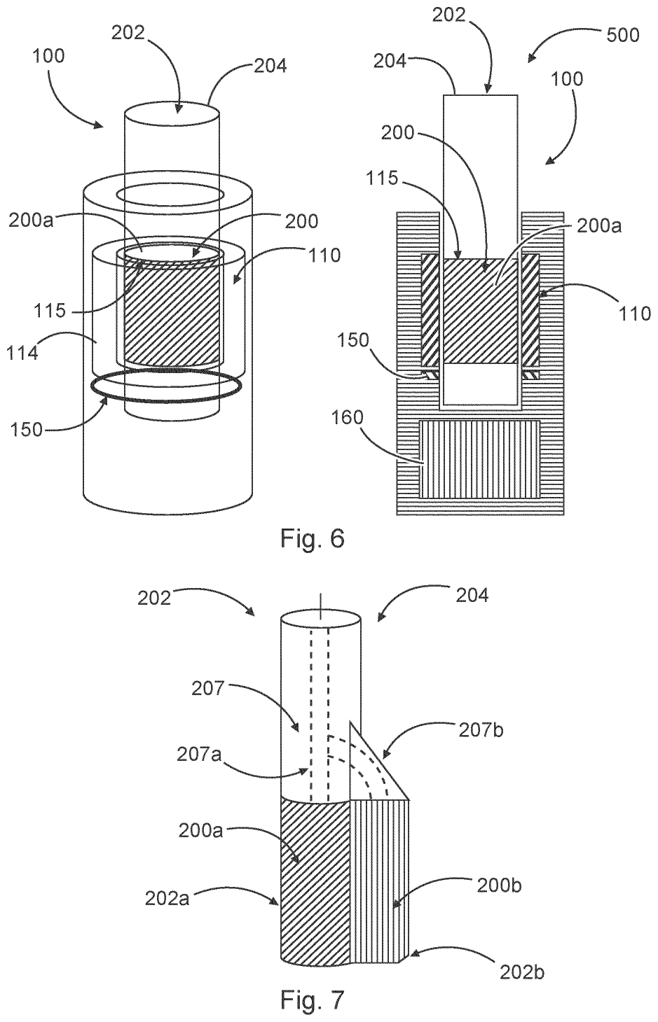

FIG. 6 shows an aerosol-generating system for generating aerosol;

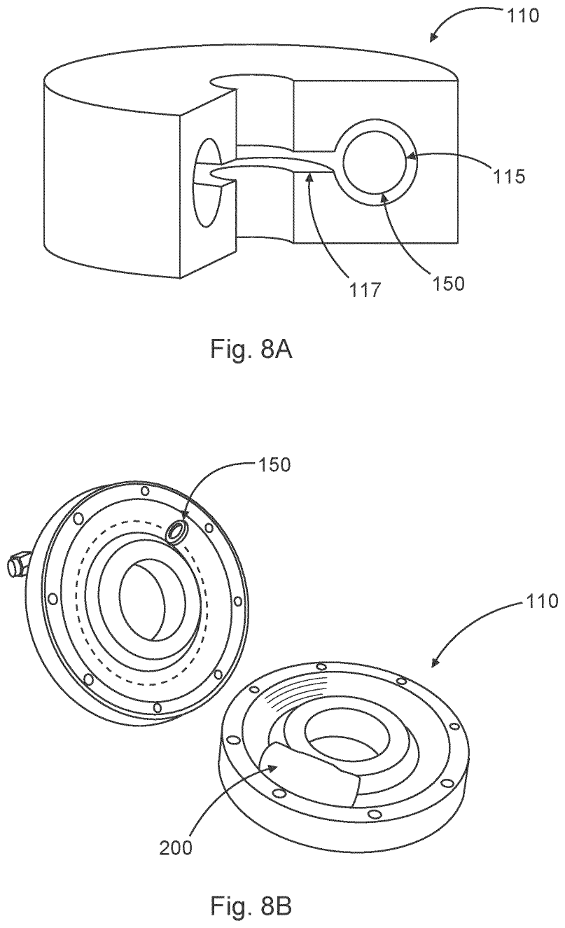

FIG. 7 shows an aerosol-generating article for generating aerosol;

FIGS. 8A and 8B show a loop-gap resonator for an aerosol-generating device for generating aerosol;

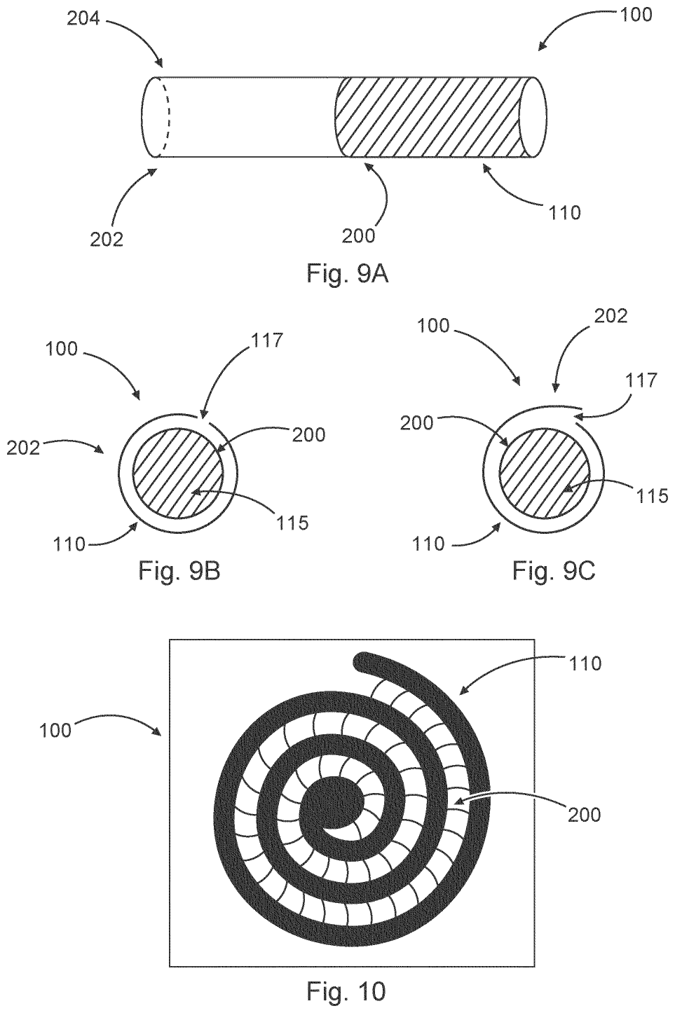

FIGS. 9A to 9C show an aerosol-generating device for generating aerosol;

FIG. 10 shows an aerosol-generating device for generating aerosol;

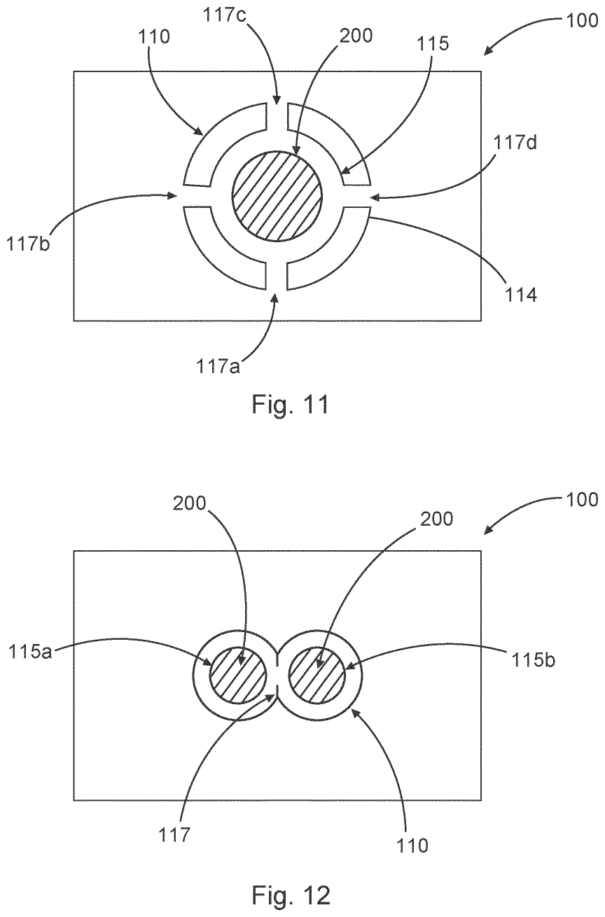

FIG. 11 shows an aerosol-generating device for generating aerosol; and

FIG. 12 shows an aerosol-generating device for generating aerosol.

The Figures are schematic only and not true to scale. In principle, identical or like parts, elements and/or steps are provided with identical or like reference numerals in the figures.

FIG. 1 shows a cross-sectional view of an aerosol-generating system 10 with an aerosol-generating device 12 and an aerosol-generating article 14. FIG. 1 may particularly serve for illustrating currently used conventional aerosol-generating systems or devices as well as heating techniques implemented therein.

In the example shown in FIG. 1, the aerosol-generating article 14 is at least partly received by the aerosol-generating device 12. For example, at least a part of the aerosol-generating article 14 may be arranged in a heating chamber 11 of the aerosol-generating device 12. The exemplary aerosol-generating article 14 of FIG. 1 is stick-like formed and comprises an aerosol-generating substrate 16 that substantially fills an interior volume of the aerosol-generating article 14. Such aerosol-generating articles 14 can also be referred to as “consumables” that are replaceable by a user, and the substrate can also be referred to as “sensorial media”.

To heat the aerosol-generating article 14 and/or the aerosol-generating substrate 16 thereof, the aerosol-generating device 12 includes a resistance heating blade 18 for resistively heating the substrate 16 based on supplying electrical energy to the blade 18. The heating blade 18 may for example be arranged with one end at a bottom of the heating chamber 11 and/or may be arranged in a centre part of the heating chamber 11. The heating chamber 11 may be defined by a hollow core, for instance a tubular core, in an interior volume of the aerosol-generating device 12. Further, the heating blade 18 may be coupled or connected to an electronics part 13 of the aerosol-generating device 21, such as for example a power supply circuitry 13 for supplying electrical power to the heating blade 18.

The aerosol-generating article 14 may be inserted into the aerosol-generating device 12, such that the heating blade 18 is preferably arranged at a centre of the aerosol-generating article 14 and is at least partly surrounded by the aerosol-generating substrate 16 thereof. In order to increase an effective heating surface of the heating blade 18, the heating blade 18 may be thin and flat. As a consequence, the blade 18 may be subject to mechanical deformation or deterioration, inter alia due to the repeated process of inserting and removing aerosol-generating articles 14 into and from the device 12, as the heating blade 18 may be pushed into the substrate 16 and pulled out of the substrate 16 in these processes.

Further, at each insertion and removal process, the heating blade 18 may be oriented or arranged differently with respect to the aerosol-generating substrate 16 and the internal configuration of the aerosol-generating article may differ from usage session to usage session. In case of a stick shaped aerosol-generating article 14, for example, the aerosol-generating substrate 16 may comprise at least one longitudinally folded Tobacco Cast Leaves (“TCL”) sheet that is compressed into a rod. According to the orientation of the blade 18 inside the consumable 14, folds of the substrate 16 (“TCL folds”) can have an orientation varying from parallel to perpendicular relative to the heating blade 18. In particular, the folds may be randomly oriented with respect to the blade 18. Hence, different aerosol-generating articles 14, for example articles 14 used at different usage sessions, may be heated differently by the blade 18, which may affect the generation of aerosol and lead to differing experiences for the user among various usage sessions. Preferably, however, a consistent experience should be provided to the user among various usage sessions.

Apart from that, heat received by different portions 16a, 16b or volumes 16a, 16b of substrate 16 inside the aerosol-generating article 14 may depend on the distance of the respective portion 16a, 16b to the heating blade 18. The planar geometry of the heating blade 18 reported to the, for example, cylindrical shape of the aerosol-generating article 14 may result in less heating of portions 16b that are farther away from the blade 18, for example in a direction transverse or perpendicular to a longitudinal direction of the blade 18 and/or the aerosol-generating article 14, when compared to portions 16a that are arranged close to the blade 18. As a result, some portions of the substrate 16 that are relatively far away from the blade 18, for example portion 16b, may be insufficiently heated to generate aerosol or may not be heated to a sufficiently high temperature to generate aerosol, while other portions that are arranged close to the blade 18, such as portion 16a, may be over heated or heated to a too high temperature. Accordingly, certain portions may be wasted while others may be over heated.

FIG. 2 shows a perspective view of a part of an aerosol-generating system 10. Unless stated otherwise, the system 10 of FIG. 2 comprises the same features, functions and elements as the system described with reference to FIG. 1.

In the example shown in FIG. 2, a susceptor 18 or susceptor material 18 is arranged in a centre of an aerosol-generating article 14 or consumable 14 in order to heat the aerosol-generating substrate 16 contained in the aerosol-generating article 14 based on induction heating. The susceptor 18 can, for example, comprise a planar metal band, and comprise a material that is both electrically conductive and electrically resistive, for example ferromagnetic material or stainless steel, positioned in the centre of the aerosol-generating article 14, surrounded by aerosol-generating substrate 16. Preferably, a central longitudinal axis 15 of the susceptor 18 is substantially aligned with a central longitudinal axis 15 of the aerosol-generating article 14. Further, a length of the susceptor along axis 15 may substantially match a length of the aerosol-generating article 14 and/or a width of the susceptor 18 may be slightly smaller than a width of the article 14, wherein the widths may be measured transverse to the longitudinal axis 15.

When the user activates the aerosol-generating device 12 or the heating system thereof, an alternating electromagnetic field is generated in the device 12, thereby creating or inducing eddy currents in the susceptor 18, and dissipation of these currents in the susceptor 18 heats the susceptor 18 and the substrate 16 surrounding it, based on Joules law, in order to generate aerosol.

Using induction heating and a susceptor band 18 may be mechanically robust, for example when compared to the design of the system of FIG. 1. However, such system 10 may nonetheless exhibit variations of heating according to the distance between a heated portion or volume of substrate 16 to the susceptor 18 (in a direction transverse or perpendicular to axis 15) and according to a relative orientation of structures in the substrate 16, such as folds, with respect to the susceptor 18.

A homogenous induction heating of a consumable 14 or aerosol-generating article 14 may adequately address a relation between a spatial distribution and properties of the susceptor 18 or susceptor material 18, for example taking into account the so-called “skin effect”, which refers to the fact that eddy currents remain mainly on the surface of the susceptor material 18, in particular when high frequencies of the current are induced, as well as a spatial distribution and properties of the alternating magnetic field, such as the frequency of the magnetic field. For instance, the overall heat transferred to a region or portion of an aerosol-generating article 14 where the intensity of the alternating magnetic field is low and where there is a high density of susceptor surface or material could be the same as of another region or portion with opposite characteristics, for example a high intensity of alternating magnetic field but low density of susceptor surface or material.

Further, electronics for aerosol-generating systems 10 and devices 12 may have constraints regarding the electromagnetic radiation or waves emitted by the device 12 or system 10. For instance, microwave frequencies of an unlicensed range, such as the 2.4 GHz ISM band (“Industrial, Scientific, Medical band”), may be used and/or a power level may be below about 15 W, below about 10 W or preferably below about 5 W. Such low power level may save energy and can extend a charge cycle time of the device 12 in case of battery driven devices 12 or systems 10.

Further, typical dimensions of an aerosol-generating article 14, in particular a stick shaped article, may be about 0.3-1.5 cm, for example 0.5-1.0 cm or 0.7-0.8 cm in diameter, and about 0.5 cm to 2 cm, for example about 1.2 cm, in length.

A heating temperature reached by the substrate 16 or a predetermined or desired temperature of the substrate 16 may be around 100° C.-300° C., for example about 200° C.-250° C.

FIG. 3 shows an aerosol generating device 100 for generating aerosol. Unless stated otherwise, the aerosol-generating device 100 of FIG. 3 comprises the same features, functions and elements as the aerosol-generating devices 12 and systems 10 described with reference to FIGS. 1 and 2.

The aerosol-generating device 100 shown in FIG. 3 is configured to receive at least a part of an aerosol-generating substrate 200 in order to generate aerosol based on heating the substrate 200. Substrate 200 may for example correspond to substrate 16 and may be comprised by a substantially stick-shaped aerosol-generating article 202 corresponding to article 14 as described with reference to FIGS. 1 and 2. Such aerosol-generating article 202 may for example include a mouthpiece 204 for the user to experience or inhale aerosol generated with the aerosol-generating device 100 during a usage session.

Alternatively or additionally, substrate 200 may comprise a liquid suppliable to the aerosol-generating device 100, for example in the form of a cartridge or container that may be refillable with substrate 200.

In order to heat the substrate 200 or at least one part thereof, the aerosol-generating device 100 includes a loop-gap resonator 110 configured to heat the at least one part of the aerosol-generating substrate 200 based on one or both of inductive heating and microwave heating, as described in detail hereinabove and hereinbelow.

The loop-gap resonator 110 may, for example, be one of a cylindrical loop-gap-resonator, a tubular loop-gap resonator, a toroidal loop-gap resonator, a spiral loop-gap resonator, a multi-loop loop-gap resonator, and a multi-gap loop-gap resonator.

The aerosol-generating device 100 may also comprise a plurality of loop-gap-resonators 110, for example arranged coaxially to a longitudinal axis 111 of the aerosol-generating device 100, of the LGR 110 and/or of the aerosol-generating article 202. In an example, at least a part of the loop-gap resonator 110 may be arranged in a heating chamber 112 of the aerosol-generating device 100.

The aerosol-generating device 100 further includes at least one electrically conductive feeding loop 150 configured to induce eddy currents, alternating current and/or electromagnetic oscillations within or in at least a part or portion of the loop-gap resonator 110. In the example shown in FIG. 3, the feeding loop 150 may be integrated or arranged in a housing of the aerosol-generating device 100, which can be a handheld device configured to at least partly receive an aerosol-generating article 202. For example, the aerosol-generating article 202 may be inserted along an insertion direction 113 parallel to the longitudinal axis 111 of the aerosol-generating device 100, of the LGR 110 and/or of the aerosol-generating article 202.

Further, the feeding loop 150 may be arranged at or near an end of the loop-gap resonator 110, for example at least partly in the heating chamber 112. Alternatively or additionally, at least one feeding loop 150 can be integrated or arranged in a part or portion of the loop-gap resonator 110.

The aerosol-generating device 100 further includes a power supply circuitry 160 configured to drive the loop-gap resonator 110 and/or the feeding loop 150 to heat the at least one part of the aerosol-generating substrate 200. Therein, the feeding loop 150 may be part of the power supply circuitry 160 of the aerosol-generating device 100. In particular, the power supply circuitry 160 can be configured to excite electromagnetic oscillations in the loop-gap resonator 110 at or near a resonance frequency of the loop-gap resonator 110. For instance, the power supply circuitry 160 can be configured to drive the loop-gap resonator 110, such that an alternating magnetic field is generated in a part or portion of the loop-gap resonator 110, in particular in a loop of the loop-gap resonator 110, configured to receive and/or encompass the at least one part of the aerosol-generating substrate 200. Alternatively or additionally, the power supply circuitry 160 can be configured to drive the loop-gap resonator 110, such that an alternating electric field is generated in a part or portion of the loop-gap resonator 110, in particular in a gap of the loop-gap resonator 110, configured to receive and/or encompass the at least one part (or a further part) of the aerosol-generating substrate 202.

The power supply circuitry 160 can further be configured to drive the loop-gap resonator 110 based on inductive coupling, for example based on supplying an alternating current to the at least one feeding loop 150, which creates an alternating magnetic field in a vicinity of the feeding loop 150, which in turn can induce eddy currents in the loop-gap resonator 110.

Alternatively or additionally, the power supply circuitry 160 can be configured to drive the loop-gap resonator 110 based on capacitive coupling. For example, the power supply circuitry 160 can include one or more electrodes configured to capacitively couple to a capacitor formed by a slit or gap of the loop-gap resonator 110, thereby capacitively inducing an alternating electric field in the capacitor formed by the slit or gap of the loop-gap resonator 110.

Alternatively or additionally, the power supply circuitry 160 can include an electromagnetic wave generator configured to excite electromagnetic oscillations in at least a portion of the loop-gap resonator 110 to drive the loop-gap resonator.

The aerosol-generating device 100 further includes at least one energy storage 170, such as at least one battery, accumulator or capacitor, in order to supply electrical energy during use of the device 100. Alternatively or additionally, the aerosol-generating device 100 may be powered by a supply grid or any other power supply.

The exemplary aerosol-generating device of FIG. 3 further includes a control circuitry 180 for controlling one or more functions of the device 100. For instance, the control circuitry 180 may be configured to actuate, activate and/or deactivate the power supply circuitry 160 to start or stop aerosol generation.

The device 100 can further comprise a user interface 190 for receiving one or more user inputs. The user interface 190 may for example be or comprise one or more of a switch element, a user-actuatable element, a button, a touch interface or the like. Therein, the control circuitry 180 may be configured to receive or process one or more user inputs received at the user interface 190 and to actuate or control the power supply circuitry 160 in correspondence, dependence and/or response to the one or more user inputs.

It is noted that the aerosol-generating device 100 and the aerosol-generating article 202 shown in FIG. 3 can constitute an aerosol-generating system 500 in the sense of the present disclosure.

FIG. 4 shows an aerosol generating system 500 for generating aerosol. Unless stated otherwise, the aerosol-generating system 500 of FIG. 4 comprises the same features, functions and elements as the aerosol-generating devices 12, 100 and systems 10, 500 described with reference to FIGS. 1 to 3.

The exemplary system 500 shown in FIG. 4 comprises an aerosol-generating device 100, which includes a loop-gap resonator 110 that is at least partly arranged and/or integrated in a cartridge 130 or container 130 configured to contain or store an aerosol-generating substrate 200. The cartridge 130 can have any suitable geometry, shape, form and/or size.

The substrate 200 may, for example, be or comprise a liquid, liquid substrate, fluid or fluid substrate. However, the substrate 200 may alternatively or additionally comprise solid components or solid substrate material.

Optionally, the substrate 200 may comprise a susceptor or susceptor material to heat the substrate 200 based on inductive heating by the loop-gap resonator 110. For example, one or more particles of ferromagnetic material may be arranged or disposed in the substrate 200, such as iron oxide particles. However, the substrate 200 or at least a part thereof may alternatively or additionally be heated based on microwave heating using the loop-gap resonator 110, as described in detail hereinabove and hereinbelow.

The aerosol-generating device 100 and/or the cartridge 130 thereof may be prefilled with substrate 200 or may be refilled by the user as desired.

To generate aerosol, the aerosol-generating device 100 can be coupled, mounted and/or attached to an external powering device 250 for driving or powering the loop-gap resonator 110, as indicated by arrow 205 in FIG. 3. For instance, the aerosol-generating device 100 may be at least partly inserted into the external powering device 250.

The external powering device 250 may, for example, be a handheld device that may have similar or identical functions and features as the aerosol-generating device 100 described with reference to FIG. 3. In particular, the external powering 250 device can comprise one or more of a power supply circuitry 160, an energy storage 170, a control circuitry 180 and a user interface 190, as described with reference to FIG. 3.

Further, the aerosol-generating system 500 comprises at least one feeding loop 150 for driving the loop-gap resonator 110. The feeding loop 150 of the system 500 shown in FIG. 4 is exemplary integrated in or arranged at the cartridge 130. Alternatively or additionally, however, the at least one feeding loop 150 may be integrated in the external powering device 250.

In order to electrically connect or couple the aerosol-generating device 100 (or cartridge 130) to the powering device 250, the aerosol-generating device 100 and/or the cartridge 130 may include one or more electrical connectors 120 for electrically coupling the feeding loop 150 or other electronic components to the power supply circuitry 160 of the external powering device 250. For instance, mechanical coupling of the aerosol-generating device 100 to the external powering device 250 may establish electronic coupling. Alternatively or additionally to the one or more electrical connectors 120, inductive or capacitive coupling can be used to drive the loop-gap resonator 110, for instance through a wall of the cartridge 130.

When activated by a user, the external powering device 250 can drive the loop-gap resonator 110 arranged at least partly in the cartridge 130 to heat the substrate 200 and generate aerosol. An air flow carrying the generated aerosol may be transported via an air flow path 210 from the heating chamber 112 to the mouthpiece 204, for example in response to inhalation of the user.

Generally, any type of loop-gap resonator 110, such as a cylindrical loop-gap-resonator, a tubular loop-gap resonator, a toroidal loop-gap resonator, a spiral loop-gap resonator, a multi-loop loop-gap resonator, and a multi-gap loop-gap resonator can be used in the devices 100 and systems 500 shown in FIGS. 3 and 4. Also, any sort of substrate or multiple substrates 200 can be used to heat the substrate(s) 200 based on induction heating and/or microwave heating using the loop-gap resonator 110. Optionally, a susceptor or susceptor material can be comprised by the one or more substrates 200 for induction heating.

FIGS. 5A and 5B each show a detailed view of a part of an aerosol generating device 100 for generating aerosol. Unless stated otherwise, the aerosol-generating device 100 of FIGS. 5A and 5B comprises the same features, functions and elements as the aerosol-generating devices 12, 100 and systems 10, 500 described with reference to FIGS. 1 to 4.

The exemplary aerosol-generating device 100 depicted in FIGS. 5A and 5B comprises a cylindrical or tubular loop-gap resonator 110 configured to heat one or more portions 200a, 200b of an aerosol-generating substrate 200.

The loop-gap resonator 110 includes a tubular body 114 that defines or at least partly encloses a loop 115 or core 115 of the loop-gap resonator 110 configured to receive and/or at least partly encompass at least one portion or part 200a of the aerosol-generating substrate 200. Accordingly, the loop 115 may refer to a compartment formed by or at least partly enclosed by at least a part of the loop-gap-resonator 110, wherein the loop 115 may be configured to at least partly encompass or surround at least portion 200a of the substrate 200. Therein, the loop-gap resonator 110 can be configured to heat the at least one part 202a of the aerosol-generating substrate 200 based on generating an alternating magnetic field within the loop 115 or core 115 of the loop-gap resonator 110.

A longitudinal axis 111 of the loop-gap resonator 110 can extend substantially parallel to an insertion direction 113 of the aerosol-generating device, along which the at least one part 200a of the aerosol-generating substrate 200 (and/or an aerosol-generating article including the aerosol-generating substrate) can be at least partly inserted into the aerosol-generating device 100 and/or the loop-gap resonator 110. For instance, a substantially stick-shaped aerosol-generating article comprising the substrate 200, portion 200a, and/or portion 200b of the substrate 200 can be inserted into the aerosol-generating device 100.

Further, the loop-gap resonator 110 includes a slit 116 extending along a length of the tubular body 113, for example parallel to the longitudinal axis 111 of the loop-gap resonator 110. The slit defines a gap 117 or gap portion 117 of the loop-gap resonator 110 configured to receive and/or at least partly encompass at least portion 200b of the aerosol-generating substrate 200. Therein, the gap 117 or slit 116 can be formed by two opposing portions, walls or parts 117a, 117b of the loop-gap resonator 110, which may be arranged opposite to each other along a circumferential direction of the loop-gap resonator 110 and/or transverse or perpendicular to the longitudinal axis 111. The loop-gap resonator 110 can be configured to heat at least portion 200b of the aerosol-generating substrate 200 based on generating an alternating electric field within the gap 117 of the loop-gap resonator 110.

It should be noted that the substrate 200 may comprise one or both of substrate portions 200a, 200b. Accordingly, substrate 200 may be formed in shape and size to fit in the loop 115 of the loop-gap resonator 110. In the example shown in FIGS. 5A and 5B, the substrate 200 may thus have a substantially cylindrical shape and form. Alternatively or additionally, substrate 200 may be formed in shape and size to fit in the gap 117. In the example shown in FIGS. 5A and 5B, the substrate 200 may thus have a substantially bar-like shaped or may be formed as parallelepiped. For illustrative purposes, portion 200b of substrate 200 is shown next to the aerosol-generating device 100 in FIG. 5B. As mentioned, substrate 200 may alternatively comprise both portions 200a, 200b. When comprising both portions 200a, 200b, the substrate material used in these portions 200a, 200b may substantially be similar or identical, for example with the only difference being that portion 200b may comprise a susceptor or susceptor material arranged, disposed and/or contained therein. However, also different substrate materials may be used for portions 200a, 200b. For instance, substrate portions 200a, 200b and/or substrate material contained therein may differ in one or more of a degree of humidity, a type of tobacco, a flavour, a taste or any other characteristic. Also, different portions 200a, 200b may be combined by the user according to personal demands.

In brief and exemplary summary, portion 200a of substrate 200 or a substrate corresponding to portion 200a may be heated by the magnetic field acting on a susceptor or susceptor material contained therein. The aerosol-generating article or consumable may be substantially stick-shaped and inserted into the loop 115 or core 115 of the LGR 110. Accordingly, portion 200a of substrate 200 may be heated based on magnetic heating.

Preferably, the susceptor material in the substrate 200 or portion 200a can be spatially homogeneously distributed inside portion 200a. For instance, the susceptor material may be small particles of ferromagnetic material inserted into and/or coated onto the substrate 200 or substrate material thereof. Alternatively or additionally, the susceptor material may be a fluid or liquid having magnetic properties added to and/or coating substrate material, for example TCL sheets. As the LGR 110 can provide an approximatively uniform alternating magnetic field in its empty central core 115 or loop 115, portion 200a of substrate 200 can be substantially uniformly heated to the desired or predetermined temperature. Accordingly, a uniformity of the quantity of heat per volume received by the substrate 200 or its material may potentially merely depend on the spatial distribution and properties of the susceptor material. Hence, uniform heating of the substrate 200 may be further supported by a homogenously distributed susceptor material in the substrate 200.

As described hereinabove, other types of susceptor or susceptor material can be used to heat portion 200a based on inductive heating. For instance, threads or bands of ferromagnetic material can be used as susceptor or susceptor material. Alternatively or additionally, ferrite slabs can be used as susceptor or susceptor material. Alternatively or additionally, also a susceptor similar to the susceptor 18 of FIG. 2 can be used.

Preferably, a volume percentage of susceptor material in the substrate 200 or portion 200a should range from about 2% to about 30%, for example from about 5% to about 20%, for example about 10%. With such volumetric filling and an exemplary working frequency or driving frequency of about 2 GHz to 3 GHz, for example about 2.4 GHz, and a power level of 0.5 W to 5 W, for example about 1 W, a temperature of about 200° C. to 300° C., for example about 250° C., can be reached after 5 to 30 seconds, for example after about 20 seconds.

Referring to portion 200b of substrate 200 that may, alternatively or additionally to portion 200a, be present in the substrate 200, the actual heating can be provided by the electric field of the LGR 110 acting on moisture, water molecules or humidity present in the substrate 200 or portion 200b. In other words, portion 200b can be heated based on microwave heating. As the LGR 110 can provide an approximatively uniform alternating electric field in the side gap 117 of the LGR 110, portion 200b can be uniformly or homogenously heated to the desired or predetermined temperature. Accordingly, a uniformity of the quantity of heat per volume received by the substrate 200 or portion 200b may potentially merely depend on the spatial distribution and properties, for example humidity, of the substrate material. Such heating may be considered as dielectric heating or microwave heating and may just need a minimum humidity level in the substrate, which may be present in any case. In other words, the substrate 200 or portion 200b can be heated based on the electric component of the electromagnetic field created in the LGR 110, in particular without requiring a susceptor material in the substrate 200. Residual humidity in the substrate 200 may be sufficient to achieve dielectric heating as desired.

Generally, an LGR 110 can be considered as an electromagnetic resonator having properties similar to a classic LCR circuit, which is a circuit that is equivalent to an inductor of inductance L, a capacitor of capacitance C and a resistor of resistance R, and optionally a generator, in series having a certain resonance frequency, which may refer to the frequency of the alternating current running in the circuit, where the current reaches its maximum and/or where the impedance of the circuit is at a minimum. Furthermore, an LGR 110 can produce electrical and magnetic fields which are approximatively uniform, at least in certain regions or portions of the LGR 110, and which are isolated from one another. One exemplary type of LGRs 110 that is usable for heating a substrate 200 is a tubular LGR 110, as shown in FIGS. 5A and 5B, with a conductive tubular body 114 cut longitudinally by a slit 116 to form a gap 117. The tubular body 114 can act as the inductor L of the circuit, the gap 117 can act as the capacitor C and the conductive metal comprised by the LGR 110 can act as the resistor R. For such LGR 110, an alternating current running transversally to the longitudinal axis 111, for example along a circumferential direction of the LGR 110, in the tubular body 114 can create a uniform magnetic field (denoted with “B” in FIG. 5A) substantially aligned with the longitudinal axis 111 of the loop-gap resonator 110 (Bio-Savart law) and a uniform alternating electric field (denoted with “E” in FIG. 5A) between the opposing walls 117a, 117b or portions 117a, 117b of or forming the gap 117. A particular advantage of these alternating electromagnetic fields generated by the LGR 110 can be seen in their uniformity and confinement to certain regions or portions of the LGR 110, such as the loop 115 and gap 117. Both fields can be physically separated and may not interfere with each other during the heating process, be it induction heating in the loop 115 or microwave heating in the gap 117.

Possible, illustrative and non-limiting physical characteristics or properties of the LGR 110 are summarized in the following. Dimensions, for example a length and/or a width, of the LGR 110 may be in the order of about ⅛ to 1/12, for instance about 1/10, of the resonant wavelength. For an exemplary targeted resonant frequency of 2.4 GHz and a phase speed approximate to the speed of light, the wavelength can be estimated to be in the range of several centimetres to several tens of centimetres, for example about 10 cm, and so the dimensions of the LGR 110 can be in the range of several millimetres to several centimetres, for instance about 0.5 cm to 5 cm. such as 1 cm.

An inner diameter of the LGR 110 and/or a diameter of the loop portion 115 can be chosen corresponding to the substrate 200 or aerosol-generating article that is to be used, for example in case of a stick-shaped aerosol-generating article comprising a substrate with susceptor. In other words, an outer diameter of the substrate 200 or portion 200a may substantially correspond to an inner diameter of the LGR 110 or a diameter of the loop portion 115. For instance, the diameter of the loop portion 115 may be slightly larger than the diameter of the substrate 200 or portion 200a. Similarly, a length of the LGR 110 can substantially match or correspond to a length of the substrate 200 of portion 200a inserted into the LGR 110 or the loop 115.

Exemplary inner diameters can range from about 0.1 cm to about 10 cm, for example from about 0.5 cm to about 5 cm, for example from about 0.6 cm to about 1.2 cm. A thickness of a wall of the tubular body 114 may range from about 0.1 mm to about 2 cm, for example from about 1 mm to about 5 mm, for example from about 1.5 mm to about 4 mm. A length of the LGR 110 may range from about 0.1 cm to about 10 cm, for example from about 0.5 cm to about 5 cm, for example from about 0.8 cm to about 1.5 cm. A width of the gap 117 of the LGR 110 may range from about 0.1 mm to about 5 cm, for example from about 0.2 mm to about 1 cm, for example from about 0.3 mm to about 3 mm.

A quality factor may be in the order of 1600-2000 in the frequency range of 1-6 GHz which may be an exemplary and non-limiting frequency range. Therein, quality factor Q may be given as the ratio between the energy stored by a resonator and the energy loss per second. The indicated Q value may be quite high, which may correspond to a good energy versus loss ratio, as average Q values for other LCR circuits are usually in the range of hundreds.

As material for the LGR 110, any electrically conductive material can be chosen, such as for example copper and/or aluminium.

As mentioned hereinabove, the LGR 110 can be fed or driven by at least one feeding loop 150, as shown in FIG. 5B. By means of the feeding loop 150, current can be inductively coupled into the LGR 110. The feeding loop 150 may refer to an electrically conductive loop, which may be arranged coaxially to the LGR 110 with respect to the longitudinal axis 111, parallel to an end or face of the LGR 110, and/or close to the end of the LGR 110. The feeding loop 150 may be fed with alternating current, which can create an alternating magnetic field around the loop 150 (Bio-Savart law), which itself can create eddy currents running transversally in the LGR 110 and/or the tubular body 114 (Faraday's law of induction). In turn, these eddy currents can generate the uniform alternating magnetic field in the centre or loop 115 of the LGR 110 and/or the alternating electric field in the gap 117.

The feeding loop 150 can, for example, be formed by using a coaxial cable, forming a loop from a portion thereof, and removing the outer conductor as well as the outside jacket and the insulator layer at this portion. The centre cable of the loop or coaxial cable may then be short circuited with the remaining of the outer conductor of the coaxial cable. The centre cable and the outer conductor of the coaxial cable can then provide two electrical terminals between which an alternating current can be generated. In such design, only the loop part of the feeding loop may generate a magnetic field, while the other parts of the coaxial cable may be shielded due to the coaxial properties.

A frequency of the alternating current running in the loop 150 can correspond to or at least be proportional to the frequency of the alternating (electro-)magnetic field(s) generated in the tubular body 114 of the LGR 110.

FIG. 6 shows an aerosol-generating system 500 for generating aerosol. Unless stated otherwise, the aerosol-generating system 500 of FIG. 6 comprises the same features, functions and elements as the aerosol-generating devices 12, 100 and systems 10, 500 described with reference to FIGS. 1 to 5B.

In FIG. 6, a perspective view and a cross-sectional view of an exemplary aerosol-generating system 500 is shown, which comprises an aerosol-generating device 100 and a substantially cylindrical or stick-like shaped consumable or aerosol-generating article 202, which includes a substrate 200 with a substrate portion 200a and a mouthpiece 204. The aerosol-generating article 202 may be at least partly inserted into the aerosol-generating device 100, such that portion 200a of the substrate may be accommodated in the loop 115 of the LGR 110 and can be heated by the LGR 110 based on inductive heating. Therein, the LGR 110 may be driven by at least one feeding loop 150 arranged at an end or bottom of the LGR 110 and/or by an electromagnetic wave generator, as described hereinabove.

Optionally, a gap of the LGR 110 may be used to heat a further portion 200b (not shown) of the substrate 200 based on microwave heating, as described hereinabove.

FIG. 7 shows an aerosol-generating article 202 for generating aerosol. Unless stated otherwise, the aerosol-generating article comprises the same features, functions and elements as the aerosol-generating articles 14, 202 described with reference to FIGS. 1 to 6.

Although not limited thereto, the aerosol-generating article 202 of FIG. 7 may be particularly suited or configured for being used in or with an aerosol-generating device 100 that includes a loop-gap resonator 110, as inter alia described with reference to previous Figures.

The aerosol-generating article 202 comprises a first portion 202a arranged and/or formed to fit in a loop 115 of a loop-gap resonator 110 of the aerosol-generating device 100, and a second portion 202b arranged and/or formed to fit in a gap 117 of the loop-gap resonator 110. Optionally, the LGR 110 can be integrated in the aerosol-generating article 202.

The first portion 202a of article 202 can be substantially cylindrically shaped. Alternatively or additionally, the second portion 202b of article 202 can be substantially bar-like shaped and/or formed as parallelepiped, for example as described with reference to FIGS. 5A and 5B.

As can be seen in FIG. 7, the aerosol-generating article 202 may be key-like shaped, wherein portion 202b can form or constitute the bit of the key. In other words, the second portion 202b can protrude fin-like from the first portion 202a of the aerosol-generating article 200.

Further, the first portion 202a can include a first aerosol-generating substrate 200a configured for being heated to generate aerosol, and the second portion 202b can include a second aerosol-generating substrate 200b configured for being heated to generate aerosol, the second aerosol-generating substrate 200b being different than the first aerosol-generating substrate 200a. For instance, the first aerosol-generating substrate 200a can include a susceptor or susceptor material configured to heat the first aerosol-generating substrate 200a based on inductive heating using the LGR 110, optionally wherein the second substrate 200b may not comprise a susceptor or susceptor material. Further, the second aerosol-generating substrate 200b can be configured for being heated based on microwave heating using the LGR 110. Alternatively or additionally, the first aerosol-generating substrate 200a and the second aerosol-generating substrate 200b can differ in one or more of a degree of humidity, a type of tobacco, a flavour, and a taste.

The aerosol-generating article 202 further includes a mouthpiece 204 and an air-flow path 207 and/or an optional filter portion 207 configured to transfer aerosol towards the mouthpiece 204 and/or to filter air flowing towards the mouthpiece 204.

Optionally, the air-flow path 207 can include a first flow-path portion 207a coupled to the first portion 202a of the aerosol-generating article 202 and configured to transfer aerosol generated in the first portion 202a of the aerosol-generating article 202 towards the mouthpiece 204. Further, the air-flow path 207 can include a second flow-path portion 207b coupled to the second portion 202b of the aerosol-generating article 202 and configured to transfer aerosol generated in the second portion 202b of the aerosol-generating article 202 towards the mouthpiece 204. Therein, the second flow-path portion 207b can be coupled to the first flow-path portion 207a upstream the mouthpiece 204, such that aerosol generated in the first portion 202a and the second portion 202b of the aerosol-generating article 202 can be mixed when transferred towards the mouthpiece 204.

Summarizing, a consumable or aerosol-generating article 202 with a key shape can be provided, allowing to use substrates 200a, 200b in different portions 202a, 202b of the article, wherein substrate 200a may comprise susceptor material and may be configured to be heated by inductive heating, whereas substrate 200b may not comprise susceptor material and may be configured to be heated based on microwave heating. Portion 202a of article 202 can be inserted into the loop 115 of the LGR and portion 202b of article 202 can be inserted into the gap 117 of the LGR 110. Such two separate or different portions 202a, 202b of the aerosol-generating article 202 or the substrate portions 200a, 200b arranged therein can offer different tastes, speeds of delivery, or the like, which may be adjusted according to individual demands. Optionally, airpath or flow-path portions 207a, 207b can guide the aerosol generated in the article 202 towards the mouthpiece 204, where the user can inhale the aerosol.

FIGS. 8A and 8B show a loop-gap resonator 110 for an aerosol-generating device 100 or system 500 for generating aerosol. The loop-gap resonator 110 of FIGS. 8A and 8B may be used in any of the devices 100 or systems 500 described with reference to FIGS. 3 to 7. Unless stated otherwise, the loop-gap resonator 110 of FIGS. 8A and 8B comprises the same features, functions and elements as the loop-gap resonators 110 described with reference to any of FIGS. 3 to 7.

The LGR 110 depicted in FIGS. 8A and 8B is a toroidal LGR 110. Such toroidal LGR 110 can be obtained by joining the two ends of a tubular or cylindrical LGR 110, for example as shown in FIGS. 5A and 5B, to form a closed structure. Therein, the magnetic field may be confined within a toroidal or donut shaped resonator or loop 115 of the toroidal LGR 110 and the gap 117 can be formed on an inner or outer perimeter thereof and extend along at least a part of a perimeter of the toroidal loop 115.

To feed or drive the LGR 110, one or more feeding loops 150 can be arranged in the loop 115 or loop portion 115 of the LGR 110. The feeding loop 150 may be driven by a power supply circuitry 160 and/or an external powering device 250 as described hereinabove.

In FIG. 8B, also at least a part or portion of a substrate 200 arranged in the loop 150 is shown. Substrate 200 may comprise susceptor or susceptor material and may be configured for being heated by the alternating magnetic field within the loop 115. Therein, substrate material may be sold and/or liquid. In particular, a solid donut-like or ring-like shaped substrate 200 may be placed in the LGR 110 of the loop 115 thereof to generate aerosol.

Alternatively or additionally, substrate 200 or a further substrate or substrate portion may be arranged in the gap 117 of the LGR 110 and may be configured for being heated by microwave heating, as described with reference to previous Figures. Also such substrate 200 can comprise solid and/or liquid substrate material, and such substrate may be substantially ring-like shaped to fit in the gap 117.

Also it should be noted that a toroidal LGR 110 may be particularly used in an aerosol-generating device 100 as described with reference to FIG. 4. Such toroidal LGR 110 can be integrated in a cartridge 130 and for example be used to heat a liquid substrate, wherein substrate may be guided towards or through the loop 115 and/or gap 117, for example by using appropriate piping or tubing.

FIGS. 9A to 9C show an aerosol-generating device 100 for generating aerosol. FIG. 9A shows a perspective view and FIGS. 9B and 9C each show a cross-sectional view for different designs of the LGR 110. Unless stated otherwise, the aerosol-generating devices 100 of FIGS. 9A to 9C comprise the same features, functions and elements as the aerosol-generating devices 100 and systems 500 described with reference to FIGS. 3 to 8B.

The aerosol-generating device 100 substantially corresponds to or can be regarded as aerosol-generating article 202 with integrated LGR 110. The aerosol-generating device 100 comprises a substrate 200 or a portion that can be filled with substrate 200 and that can be arranged in the loop 115 of the LGR 110.

In the examples shown in FIGS. 9A to 9C, the LGR 110 can be formed by a foil of electrically conductive material, which foil can be wrapped around the substrate 200 or a portion that can be filled with substrate 200. For instance, a strip of the foil, such as an aluminium foil, can be wrapped at least partially around an outer surface of the substrate 200 or the portion of the device that is fillable with substrate 200. Alternatively or additionally, a strip of the foil can be placed inside a paper or insulator wrapper, for instance forming an outside of the substrate 200 or a corresponding aerosol-generating device 100 or article 204.

In the example shown in FIG. 9B, the foil is wrapped around only a part of a perimeter of the substrate 200, such that a tubular or cylindrical LGR 110 is formed. In the example shown in FIG. 9C, the foil is wrapped around the substrate 200 such that the portions that form the gap 117 in the example of FIG. 9B overlap along a circumferential direction of the LGR 110 and are spaced apart from each other in a direction transverse thereto. Hence, the LGR 110 shown in FIG. 9C can constitute a spiral LGR 110.

Optionally, also at least one feeding loop can be integrated within the aerosol-generating device 100 and/or an aerosol-generating article corresponding thereto.

FIG. 10 shows an aerosol-generating device 100 for generating aerosol. Unless stated otherwise, the aerosol-generating device 100 of FIG. 10 comprises the same features, functions and elements as the aerosol-generating devices 100 and systems 500 described with reference to FIGS. 3 to 9C.

Similar to the device 100 shown in FIG. 9C, the aerosol-generating device 100 of FIG. 10 comprises a spiral LGR 110 for heating a substrate 200 and generating aerosol. Such spiral LGR 110 can be formed by making a sheet of electrically conductive material, for instance aluminium, on one side and paper on the other and wrapping this into a spiral shape as shown in FIG. 10. Between walls of the LGR 110, substrate 200 may be arranged and heated.

FIG. 11 shows an aerosol-generating device 100 for generating aerosol. Unless stated otherwise, the aerosol-generating device 100 of FIG. 11 comprises the same features, functions and elements as the aerosol-generating devices 100 and systems 500 described with reference to FIGS. 3 to 10.

In the example shown in FIG. 11, the LGR 110 is a multi-gap LGR 110, exemplary comprising four gaps 117a, 117d. Any other number of gaps 117a-d is conceivable. Preferably, the gaps 117a-d can be arranged symmetrical with respect to a centre axis or longitudinal axis 111 of the LGR 110. Such symmetric arrangement may allow to compensate for the influence of the electric field that each slit or gap 117a-d may have on the other slits or gaps 117a-d. Further, a plurality of gaps 117a-117d may allow to further confine the magnetic field within the loop 115 of the LGR 110.

Using such LGR 110, substrate 200 or a portion thereof may be heated in one or more of the loop 115 of the LGR 110 and one or more of the gaps 117a-d. Also, multiple substrates of same or different type can be used.

FIG. 12 shows an aerosol-generating device 100 for generating aerosol. Unless stated otherwise, the aerosol-generating device 100 of FIG. 12 comprises the same features, functions and elements as the aerosol-generating devices 100 and systems 500 described with reference to FIGS. 3 to 11.

In the example shown in FIG. 12, the LGR 110 is a multi-loop LGR 110, exemplary comprising two loops 115a, 115b and a single gap 117. Any other number of loops 115a, 115b or gap(s) 117 is conceivable.

Using such LGR 110, substrate 200 or a portion thereof may be heated in one or more of the loops 115a, 115b of the LGR 110 and the at least one gap 117. Also, multiple substrates of same or different type can be used.

For the purpose of the present description and of the appended claims, except where otherwise indicated, all numbers expressing amounts, quantities, percentages, and so forth, are to be understood as being modified in all instances by the term “about” or “substantially”. Also, all ranges include the maximum and minimum points disclosed and include any intermediate ranges therein, which may or may not be specifically enumerated herein. In this context, therefore, a number A is understood as A ±20% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-15. (canceled)

16. An aerosol-generating device configured to generate aerosol by heating at least one part of an aerosol-generating substrate, the aerosol-generating device comprising:
a loop-gap resonator configured to heat the at least one part of the aerosol-generating substrate in order to generate aerosol.

17. The aerosol-generating device according to claim 16, wherein the loop-gap resonator is further configured to heat the at least one part of the aerosol-generating substrate based on one or both of inductive heating and microwave heating.

18. The aerosol-generating device according to claim 16,
wherein at least one portion of the loop-gap resonator forms a loop of the loop-gap resonator, the loop being configured to receive the at least one part of the aerosol-generating substrate, and
wherein the loop-gap resonator is further configured to heat the at least one part of the aerosol-generating substrate based on generating an alternating magnetic field within the loop of the loop-gap resonator.

19. The aerosol-generating device according to claim 16,
wherein at least two portions of the loop-gap resonator are arranged opposite to each other and are spaced apart from each other, such that the at least two portions form a gap of the loop-gap resonator, the gap being configured to receive the at least one part of the aerosol-generating substrate, and
wherein the loop-gap resonator is further configured to heat the at least one part of the aerosol-generating substrate based on generating an alternating electric field within the gap of the loop-gap resonator.

20. The aerosol-generating device according to claim 16, wherein the loop-gap resonator is at least one of a cylindrical loop-gap-resonator, a tubular loop-gap resonator, a toroidal loop-gap resonator, a spiral loop-gap resonator, a multi-loop loop-gap resonator, and a multi-gap loop-gap resonator.

21. The aerosol-generating device according to claim 16,
wherein the loop-gap resonator is at least partly arranged in a cartridge that is at least partly fillable with or filled with the aerosol-generating substrate, and
wherein the cartridge is couplable (a) to an external powering device configured to drive the loop-gap resonator and/or (b) to a power supply circuitry of the aerosol-generating device, the power supply circuitry being configured to drive the loop-gap resonator.

22. The aerosol-generating device according to claim 16, further comprising at least one electrically conductive feeding loop configured to induce eddy currents in at least a portion of the loop-gap resonator and/or configured to excite electromagnetic oscillations in at least a portion of the loop-gap resonator.

23. The aerosol-generating device according to claim 16, further comprising a power supply circuitry configured to drive the loop-gap resonator to heat the at least one part of the aerosol-generating substrate based on exciting electromagnetic oscillations in at least a portion of the loop-gap resonator.

24. The aerosol-generating device according to claim 23,
wherein the power supply circuitry is further configured to drive the loop-gap resonator, such that an alternating magnetic field is generated in a loop of the loop-gap resonator, the loop being configured to receive the at least one part of the aerosol-generating substrate, and/or
wherein the power supply circuitry is further configured to drive the loop-gap resonator, such that an alternating electric field is generated in a gap of the loop-gap resonator, the gap being configured to receive the at least one part of the aerosol-generating substrate.

25. The aerosol-generating device according to claim 23, wherein the power supply circuitry is further configured to drive the loop-gap resonator based on inductive coupling.

26. The aerosol-generating device according to claim 23,
wherein the power supply circuitry includes at least one electrically conductive feeding loop, and
wherein the power supply circuitry is further configured to drive the loop-gap resonator based on supplying an alternating current to the at least one feeding loop.

27. The aerosol-generating device according to claim 26, wherein the at least one electrically conductive feeding loop is arranged coaxially with a loop of the loop-gap resonator.

28. The aerosol-generating device according to claim 23, wherein the power supply circuitry is further configured to excite electromagnetic oscillations in the loop-gap resonator at or near a resonance frequency of the loop-gap resonator.

29. The aerosol-generating device according to claim 16,
wherein the loop-gap resonator includes a tubular body, the tubular body defining a loop of the loop-gap resonator configured to receive the at least one part of the aerosol-generating substrate, and
wherein the loop-gap resonator is further configured to heat the at least one part of the aerosol-generating substrate based on generating an alternating magnetic field within the loop of the loop-gap resonator.

30. The aerosol-generating device according to claim 16,
wherein the loop-gap resonator includes a tubular body with a slit, the slit defining a gap of the loop-gap resonator configured to receive the at least one part of the aerosol-generating substrate, and
wherein the loop-gap resonator is further configured to heat the at least one part of the aerosol-generating substrate based on generating an alternating electric field within the gap of the loop-gap resonator.

31. A loop-gap resonator in an aerosol-generating device, the loop-gap resonator being configured to heat at least a part of an aerosol-generating substrate.

32. An aerosol-generating article for an aerosol-generating device, the aerosol-generating article comprising:
a first portion arranged and/or formed to fit in a loop of a loop-gap resonator of the aerosol-generating device; and
a second portion arranged and/or formed to fit in a gap of the loop-gap resonator.

33. The aerosol-generating article according to claim 32, further comprising a loop-gap resonator configured to heat one or both of the first portion and the second portion of the aerosol-generating article.

34. The aerosol-generating article according to claim 32, wherein the first portion is substantially cylindrically shaped.

35. An aerosol-generating system, comprising:
an aerosol-generating device according to claim 16; and
an aerosol-generating article comprising
a first portion arranged and/or formed to fit in a loop of a loop-gap resonator of the aerosol-generating device, and
a second portion arranged and/or formed to fit in a gap of the loop-gap resonator.
